(19) United States
(12) Patent Application Publication
(10) Pub. No.: US 2018/0183788 A1
(43) Pub. Date: Jun. 28, 2018

(54) ELECTRONIC APPARATUS, CONTROL AUTHORITY AUTHENTICATION METHOD THEREOF AND USER TERMINAL APPARATUS

(71) Applicant: Samsung Electronics Co., Ltd., Suwon-si (KR)

(72) Inventors: Young-jin KIM, Yongin-si (KR); Yeong-hun NAM, Suwon-si (KR); Eun-ok SHIN, Suwon-si (KR); Ji-hyeok KIM, Incheon (KR)

(21) Appl. No.: 15/847,212

(22) Filed: Dec. 19, 2017

(30) Foreign Application Priority Data
Dec. 22, 2016 (KR) 10-2016-0176458

(51) Int. Cl. H04L 29/06; H04W 12/06

(52) U.S. Cl. CPC H04L 63/0853; H04W 12/06

(57) ABSTRACT

An electronic apparatus is provided. The electronic apparatus includes a communicator configured to communicate with a guest terminal apparatus requesting control authority for the electronic apparatus and an owner terminal apparatus having approval authority for a control of the electronic apparatus, a storage, and a processor configured to transmit an approval request for the control authority request to the owner terminal apparatus when the control authority request is received from the guest terminal apparatus, generate authentication information for control authority authentication of the guest terminal apparatus to store the generated authentication information in the storage and to transmit the generated authentication information to the guest terminal apparatus, when an approval for the approval request is received from the owner terminal apparatus, and match received authentication information and the stored authentication information to each other and to determine whether a control command is performed, when the authentication information and the control command for the electronic apparatus are received from the guest terminal apparatus.

### CROSS-REFERENCE TO RELATED APPLICATION(S)

This application claims the benefit under 35 U.S.C. §119(a) of a Korean patent application filed on Dec. 22, 2016 in the Korean Intellectual Property Office and assigned Serial number 10-2016-0176458, the entire disclosure of which is hereby incorporated by reference.

### TECHNICAL FIELD

The present disclosure relates to an electronic apparatus, a control authority authentication method thereof, and a user terminal apparatus. More particularly, the present disclosure relates to an electronic apparatus authenticating and processing a control authority, a control authority authentication method thereof, and a user terminal apparatus.

### BACKGROUND

As an electronic technology has developed, there have been a myriad of network environments, such as a home network or Internet of things (IoT). More particularly, IoT refers to a technology of embedding sensors and communication functions in a variety of things and connecting the things to Internet. Here, the things may be various embedded systems, such as a variety of home appliances, mobile devices, wearable computers, and the like.

In such an IoT environment, a user may control a variety of electronic apparatuses by using a terminal apparatus. For example, the user may control operations of the electronic apparatuses, such as an air conditioner, refrigerator, a washing machine, a television (TV), and the like in the home by using a smartphone.

Here, the user terminal apparatus for controlling the electronic apparatus needs to have authority to control the corresponding electronic apparatus, a separate authentication server is generally used for control authority authentication of the electronic apparatus according to the related art.

However, in the case in which the control authority is authenticated by using the separate authentication server, since authentication information of the user needs to be transmitted to the server, a privacy or security problem may occur.

Further, an authentication method based on the authentication server, such as existing open authorization (OAuth) or (OpenID) does not have a separate authority control feature for an IoT device, and since it requires hypertext transfer protocol (HTTP) communication even in a case in which the authority control feature is supported, it requires a periodic key exchange with the authentication server and is not suitable for an IoT environment based on a low-specification device.

Therefore, a need exists for a technology capable of authenticating and processing the control authority between IoT devices without the server, in the IoT environment.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above mentioned problems and/or disadvantages and to provide at least the advantages described below. Accordingly, an aspect of present disclosure is to provide an electronic apparatus capable of authenticating and processing control authority for the electronic apparatus without a server, and a control authority authentication method thereof, and a user terminal apparatus.

In accordance with an aspect of the present disclosure, an electronic apparatus is provided. The electronic apparatus includes a communicator configured to communicate with a guest terminal apparatus requesting control authority for the electronic apparatus and an owner terminal apparatus having approval authority for a control of the electronic apparatus, a storage, and a processor configured to transmit an approval request for the control authority request to the owner terminal apparatus when the control authority request is received from the guest terminal apparatus, generate authentication information for control authority authentication of the guest terminal apparatus to store the generated authentication information in the storage and to transmit the generated authentication information to the guest terminal apparatus, when an approval for the approval request is received from the owner terminal apparatus, and match received authentication information and the stored authentication information to each other and to determine whether a control command is performed, when the authentication information and the control command for the electronic apparatus are received from the guest terminal apparatus.

The processor may transmit information on a plurality of functions which are performed in the electronic apparatus to the guest terminal apparatus, when a request for the information on the plurality of functions which are performed in the electronic apparatus is received from the guest terminal apparatus, and transmit an approval request for at least one function for which the control authority is requested to the owner terminal apparatus, when a control authority request for the at least one function of the plurality of functions which are performed in the electronic apparatus is received from the guest terminal apparatus.

The storage may store a list of owner terminal apparatuses having the approval authority for the control of the electronic apparatus, and the processor may transmit the list of the owner terminal apparatuses to the guest terminal apparatus, when the control authority request is received from the guest terminal apparatus, and transmit the approval request to a selected owner terminal apparatus, when information on the owner terminal apparatus selected from the list of the owner terminal apparatuses is received from the guest terminal apparatus.

The authentication information may include information on the owner terminal apparatus approving the approval request and information on the approved control authority.

The authentication information may include information on an expiration time of the control authority for the electronic apparatus of the guest terminal apparatus, and the processor may not perform the control command received from the guest terminal apparatus, when the expiration time included in the authentication information received from the guest terminal apparatus elapses.

The processor may transmit a performance result message to the guest terminal apparatus after performing the control command, when the received authentication information and the stored authentication information are matched to each other as a matching result of the authentication information, and transmit a message informing that the guest terminal apparatus does not have authority to control the electronic apparatus to the guest terminal apparatus, when the received authentication information and the stored authentication information are not matched to each other.

The owner terminal apparatus may have approval authority for a control of the electronic apparatus and a different electronic apparatus, and the processor may transmit approval requests for the respective control authorities requested to the electronic apparatus and the different electronic apparatus to the owner terminal apparatus, when information on the control authority that the guest terminal apparatus requests to the different electronic apparatus is received from the guest terminal apparatus, and generate authentication information for control authority authentication for the electronic apparatus and the different electronic apparatus of the guest terminal apparatus to store the generated authentication information in the storage, and transmit the generated authentication information to the guest terminal apparatus, when an approval for the respective control authorities is received from the owner terminal apparatus.

The processor may transmit specification information of the electronic apparatus including at least one of a type of power supply, memory capacity, a communication manner, and a processor speed of the electronic apparatus to the guest terminal apparatus, and receive information on the control authority that the guest terminal apparatus requests to the different electronic apparatus from the guest terminal apparatus, when the electronic apparatus is selected among the electronic apparatus and the different electronic apparatus based on the specification information of the electronic apparatus and the specification information of the different electronic apparatus in the guest terminal apparatus.

The processor may determine whether the stored authentication information is included in received integrated authentication information to determine whether the control command is performed, when the integrated authentication information in which a plurality of authentication information are integrated and the control command are received from the guest terminal apparatus, and the integrated authentication information may include at least two or more of authentication information controlling at least one function of a plurality of functions which are performed in the electronic apparatus, authentication information controlling a function different from the at least one function of the plurality of functions which are performed in the electronic apparatus, and authentication information controlling a different electronic apparatus.

In accordance with another aspect of the present disclosure, a control authority authentication method of an electronic apparatus is provided. The method includes receiving a control authority request from a guest terminal apparatus requesting control authority for the electronic apparatus, transmitting an approval request for the control authority request to an owner terminal apparatus having approval authority for a control of the electronic apparatus, generating and storing authentication information for control authority authentication of the guest terminal apparatus, when an approval for the approval request is received from the owner terminal apparatus, transmitting the generated authentication information to the guest terminal apparatus, and matching received authentication information and the stored authentication information to each other to determine whether the control command is performed, when the authentication information and the control command for the electronic apparatus are received from the guest terminal apparatus.

The control authority authentication method may further include transmitting information on a plurality of functions which are performed in the electronic apparatus to the guest terminal apparatus, when a request for the information on the plurality of functions which are performed in the electronic apparatus is received from the guest terminal apparatus, wherein, in the receiving of the control authority request, a control authority request for the at least one function of the plurality of functions which are performed in the electronic apparatus may be received from the guest terminal apparatus, and in the transmitting of the approval request for the control authority request to the owner terminal apparatus, an approval request for at least one function for which the control authority is requested may be transmitted to the owner terminal apparatus.

The control authority authentication method may further include transmitting a list of owner terminal apparatuses having the approval authority for the control of the electronic apparatus to the guest terminal apparatus, when the control authority request is received from the guest terminal apparatus, wherein the transmitting of the approval request for the control authority request to the owner terminal apparatus may include receiving information on the owner terminal apparatus selected from the list of the owner terminal apparatuses from the guest terminal apparatus, and transmitting the approval request to the selected owner terminal apparatus.

The authentication information may include information on the owner terminal apparatus approving the approval request and information on the approved control authority.

The authentication information may include information on an expiration time of the control authority for the electronic apparatus of the guest terminal apparatus, and in the determining of whether the control command is performed, the control command received from the guest terminal apparatus may not be performed, when the expiration time included in the authentication information received from the guest terminal apparatus elapses.

The control authority authentication method may further include transmitting a performance result message to the guest terminal apparatus after performing the control command, when the received authentication information and the stored authentication information are matched to each other, and transmitting a message informing that the guest terminal apparatus does not have authority to control the electronic apparatus to the guest terminal apparatus, when the received authentication information and the stored authentication information are not matched to each other.

The owner terminal apparatus may have approval authority for a control of the electronic apparatus and a different electronic apparatus, in the transmitting of the approval request for the control authority request to the owner terminal apparatus, approval requests for the respective control authorities requested to the electronic apparatus and the different electronic apparatus may be transmitted to the owner terminal apparatus, when information on the control authority that the guest terminal apparatus requests to the different electronic apparatus is received from the guest terminal apparatus, and in the generating and storing of the authentication information, authentication information for control authority authentication for the electronic apparatus and the different electronic apparatus of the guest terminal apparatus may be generated and stored, when an approval for the respective control authorities is received from the owner terminal apparatus.

The control authority authentication method may further include transmitting specification information of the electronic apparatus including at least one of a type of power supply, memory capacity, a communication manner, and a processor speed of the electronic apparatus to the guest terminal apparatus, wherein, in the transmitting of the approval request for the control authority request to the owner terminal apparatus, information on the control authority that the guest terminal apparatus requests to the different electronic apparatus may be received, when the electronic apparatus is selected among the electronic apparatus and the different electronic apparatus based on the specification information of the electronic apparatus and the specification information of the different electronic apparatus in the guest terminal apparatus.

In the determining of whether the control command is performed, whether the stored authentication information is included in received integrated authentication information may be determined to determine whether the control command is performed, when the integrated authentication information in which a plurality of authentication information are integrated and the control command are received from the guest terminal apparatus, and the integrated authentication information may include at least two or more of authentication information controlling at least one function of a plurality of functions which are performed in the electronic apparatus, authentication information controlling a function different from the at least one function of the plurality of functions which are performed in the electronic apparatus, and authentication information controlling a different electronic apparatus.

In accordance with another aspect of the present disclosure, a user terminal apparatus is provided. The user terminal apparatus includes a communicator configured to communicate with an electronic apparatus, and a processor configured to transmit a control authority request for the electronic apparatus to the electronic apparatus, and to control an operation of the electronic apparatus by using received authentication information, when the control authority request is approved by an owner terminal apparatus having approval authority for a control of the electronic apparatus and the authentication information for control authority authentication for the electronic apparatus of the user terminal apparatus is received from the electronic apparatus.

In accordance with another aspect of the present disclosure, the electronic apparatus may authenticate and process the control authority without the server in the Internet of things (IoT) environment. Accordingly, the privacy or security issue of the user which may occur during the control authority authentication may be addressed, and the authority control feature which is more suitable for the IoT environment may be supported.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is an illustrative diagram of a control authority authentication and processing system according to an embodiment of the present disclosure;

FIG. 2 is a block diagram of an electronic apparatus according to an embodiment of the present disclosure;

FIG. 3 is an illustrative diagram illustrating a process of requesting, by a guest terminal apparatus, control authority for an electronic apparatus according to an embodiment of the present disclosure;

FIG. 4 is an illustrative diagram illustrating a process of generating, by an electronic apparatus, authentication information and transmitting it to a guest terminal apparatus according to an embodiment of the present disclosure;

FIG. 5 is an illustrative diagram illustrating a process of controlling, by a guest terminal apparatus, an electronic apparatus using an authentication information according to an embodiment of the present disclosure;

FIG. 6 is an illustrative diagram illustrating a process of requesting, by a guest terminal apparatus, control authority to a plurality of electronic apparatuses according to an embodiment of the present disclosure;

FIG. 7 is an illustrative diagram illustrating a process of generating, by an electronic apparatus, authentication information for a plurality of electronic apparatuses and transmitting it to a guest terminal apparatus according to an embodiment of the present disclosure;

FIG. 8 is an illustrative diagram illustrating a process of controlling, by a guest terminal apparatus, a plurality of electronic apparatuses using authentication information according to an embodiment of the present disclosure;

FIG. 9 is an illustrative diagram illustrating integrated authentication information which may be stored in a guest terminal apparatus according to an embodiment of the present disclosure;

FIG. 10 is a block diagram of a user terminal apparatus according to an embodiment of the present disclosure;

FIGS. 11A, 11B, 11C, 11D, 11E, 11F, and 11G are illustrative diagrams of user interfaces (UIs) which may be displayed on a guest terminal apparatus and an owner terminal apparatus in a processing of authenticating and processing control authority according to an embodiment of the present disclosure;

FIG. 12 is a flowchart illustrating a control authority authentication method of an electronic apparatus according to an embodiment of the present disclosure; and

FIG. 13 is a sequence diagram illustrating an operation of a control authority authentication and processing system according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terms used in the present specification are used to describe embodiments and are not intended to limit and/or to restrict the present disclosure. As used herein, the singular forms are intended to include plural forms as well, unless the context clearly indicates otherwise.

In the present specification, it will be understood that the terms “comprises” or “have” specify the presence of stated features, numerals, operations, components, parts, or a combination thereof, but do not preclude the presence or addition of one or more other features, numerals, operations, components, parts, or a combination thereof.

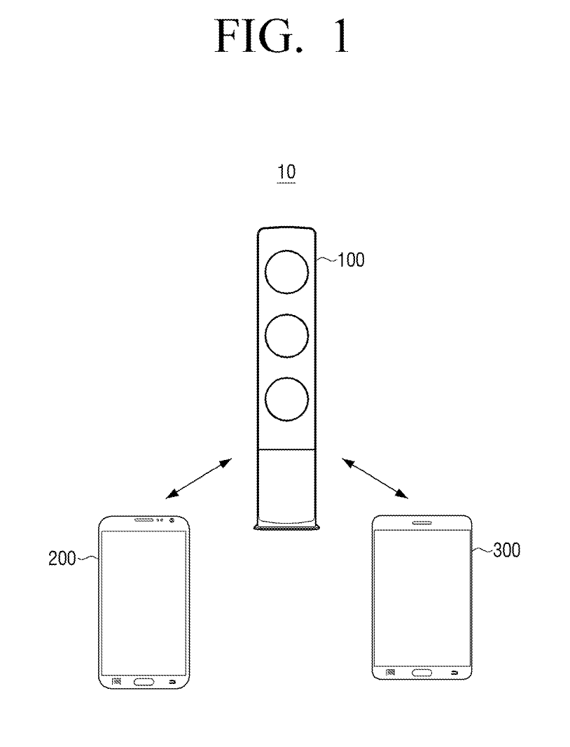

FIG. 1 is an illustrative diagram of a control authority authentication and processing system according to an embodiment of the present disclosure.

Referring to FIG. 1, a control authority authentication and processing system 10 may include an electronic apparatus 100, a guest terminal apparatus 200, and an owner terminal apparatus 300. Here, the guest terminal apparatus 200 and the owner terminal apparatus 300 may be a variety of portable terminal apparatuses, such as a smartphone, a personal digital assistant (PDA), a tablet personal computer (PC), a notebook, a portable multimedia player (PMP), a moving picture experts group phase 1 or phase 2 (MPEG-1 or MPEG-2) audio layer 3 (MP3) player, and the like, but are not limited thereto.

The guest terminal apparatus 200, which is a terminal apparatus carried by other people (hereinafter, referred to as a guest) other than an owner of the electronic apparatus 100 (hereinafter, referred to as an owner), refers to a terminal apparatus that the guest uses to control the electronic apparatus 100.

The guest terminal apparatus 200 may request control authority for controlling the electronic apparatus 100 to the electronic apparatus 100 according to an operation of the guest, and when the control authority request is approved by the owner terminal apparatus 300 and authentication information capable of controlling the electronic apparatus 100 is received from the electronic apparatus 100, the guest terminal apparatus 200 may control the electronic apparatus 100 by using the received authentication information.

The owner terminal apparatus 300, which is a terminal apparatus carried by an owner of the electronic apparatus 100, has approval authority for the control of the electronic apparatus 100. The owner terminal apparatus 300 may receive a control authority approval request for the electronic apparatus 100 of the guest terminal apparatus 200 from the electronic apparatus 100, and transmit a response (an approval or disapproval message) for the approval request to the electronic apparatus 100 according to an operation of the owner.

When the electronic apparatus 100 receives the control authority request from the guest terminal apparatus 200, it may transmit the approval request for the requested control authority to the owner terminal apparatus 300, and when the electronic apparatus 100 receives an approval for the approval request from the owner terminal apparatus 300, the electronic apparatus 100 may generate and store authentication information for control authority authentication of the guest terminal apparatus 200 and transmit the generated authentication information to the guest terminal apparatus 200.

Accordingly, the guest terminal apparatus 200 may control the electronic apparatus 100 by using the received authentication information. Specifically, when the guest terminal apparatus 200 transmits a control command for controlling the electronic apparatus 100 together with the authentication information to the electronic apparatus 100 according to an operation of the guest, the electronic apparatus 100 receives it and matches the received authentication information with stored authentication information to determine whether the control command is performed.

As a result of the matching, when the received authentication information and the stored authentication information are matched, the electronic apparatus 100 may perform the control command and transmit a performance result message to the guest terminal apparatus 200, and when received authentication information and the stored authentication information are not matched, the electronic apparatus 100 does not perform the control command and transmits a message informing that there is no authority to control the electronic apparatus 100 to the guest terminal apparatus 200.

One example to which such a control authority authentication and processing system 10 may be actually applied is as follows. For example, when a guest visits the restaurant A, the guest may directly operate an air conditioner 100 installed in the restaurant A by using the guest terminal apparatus 200. However, since the guest terminal apparatus 200 of the guest who first visits the restaurant A does not have authentication information capable of controlling the air conditioner 100, the guest may not control the air conditioner 100 by using the guest terminal apparatus 200.

Here, the guest may request control authority to the air conditioner 100 by using the guest terminal apparatus 200. When the air conditioner 100 receives the control authority request from the guest terminal apparatus 200, the air conditioner 100 transmits an approval request for the requested control authority to an owner terminal apparatus 300 carried by an owner (most likely the same person as the restaurant owner) of the air conditioner 100.

The owner terminal apparatus 300 may receive and display the approval request transmitted from the electronic apparatus 100, and the restaurant owner may know that the guest who has visited his restaurant wants to directly operate the air conditioner 100. Accordingly, when the restaurant owner allows the guest to operate the air conditioner 100 through the owner terminal apparatus 300, the owner terminal apparatus 300 may transmit an approval for the approval request to the air conditioner 100.

The air conditioner 100 receives the approval message from the owner terminal apparatus 300, and the air conditioner 100 generates and stores the authentication information for the control authority authentication for the air conditioner 100 of the guest terminal apparatus 200 of the guest and transmits the generated authentication information to the guest terminal apparatus 200.

Accordingly, the guest terminal apparatus 200 may control the air conditioner 100 by using the authentication information received from the air conditioner 100. For example, when the guest inputs a control command for lowering a setting temperature of the air conditioner 100 to the guest terminal apparatus 200 after the guest terminal apparatus 200 receives the authentication information from the air conditioner 100, the guest terminal apparatus 200 may transmit the authentication information together with the input control command to the air conditioner 100, and the air conditioner 100 may match the authentication information received from the guest terminal apparatus 200 with the stored authentication information, may lower the setting temperature of the air conditioner 100 when the received authentication information and the stored authentication information are matched, and may then transmit a message informing that the setting temperature of the air conditioner 100 is lowered to the guest terminal apparatus 200.

As such, according to the control authority authentication and processing system 10 according to an embodiment of the present disclosure, the electronic apparatus 100 may authenticate and process the control authority for the user terminal apparatus to control the electronic apparatus 100 without a server.

Meanwhile, the air conditioner 100 is described as one example of the electronic apparatus, but the example of the electronic apparatus 100 is not limited thereto. For example, the electronic apparatus 100 may be implemented as a variety of devices capable of configuring an Internet of things (IoT) environment, such as a television (TV), an electronic frame, a large format display (LFD), a sound bar, a cleaner, a washing machine, a refrigerator, a door lock, a heater, a router, a microwave oven, and the like. For example, according to an embodiment of the present disclosure, the guest terminal apparatus 200, the electronic apparatus 100, and the owner terminal apparatus 300 may configure a portion of the IoT environment.

Further, the terminal apparatuses of the guest and the owner are referred to as the guest terminal apparatus 200 and the owner terminal apparatus 300, respectively, but are merely names given for convenience of explanation, and the configurations and types of the guest terminal apparatus 200 and the owner terminal apparatus 300 are not limited by their names. For example, all of the terminal apparatuses that the guest that does not initially have usage authority for the electronic apparatus 100 may use to control the electronic apparatus 100 may be the guest terminal apparatus 200, and all of the terminal apparatuses of the owner of the electronic apparatus 100 or a person having authority capable of determining whether the usage authority of the electronic apparatus 100 is approved even if the person is not the owner of the electronic apparatus may be the owner terminal apparatus 300.

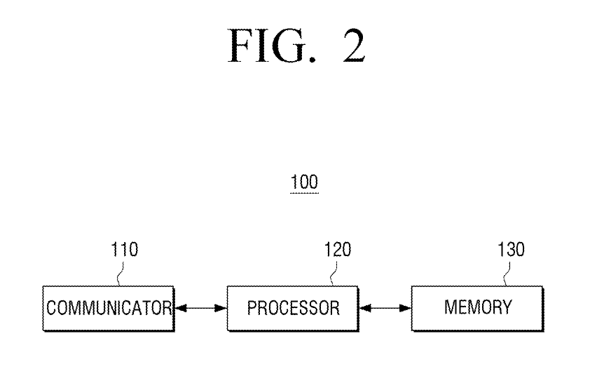

Hereinafter, diverse embodiments of the electronic apparatus 100 will be described with reference to FIG. 2.

FIG. 2 is a block diagram illustrating a configuration of an electronic apparatus according to an embodiment of the present disclosure.

Referring to FIG. 2, the electronic apparatus 100 may include a communicator 110, a processor 120, and a storage 130.

The electronic apparatus 100 may further include one or more other configurations for performing a unique function of the electronic apparatus 100 according to the type of electronic apparatus 100 other than the configurations illustrated in FIG. 2. Since a detailed description thereof is out of the subject matter of the present disclosure, the configuration for performing the unique function of the electronic apparatus 100 is not separately illustrated. However, in the case in which it is necessary to describe the diverse embodiments of the present disclosure, the corresponding configuration will be described.

The communicator 110 performs communications with an external terminal apparatus. More particularly, the communicator 110 may transmit and receive a variety of information by performing communications with the guest terminal apparatus 200 requesting the control authority for the electronic apparatus and the owner terminal apparatus 300 having the approval authority for the control of the electronic apparatus 100.

To this end, the communicator 110 may include at least one communication module of a local area wireless communication module (not illustrated), and a wireless local area network (WLAN) communication module (not illustrated). Here, the local area wireless communication module (not illustrated), which is a communication module wirelessly performing data communication with the guest terminal apparatus 200 and the owner terminal apparatus 300 located at a local area, may include, for example, a Bluetooth module, a ZigBee module, a near field communication (NFC) module, and the like. Further, the WLAN communication module (not illustrated) is a module connected to an external network according to a wireless communication protocol, such as Wi-Fi, institute of electrical and electronics engineers (IEEE), or the like, to perform communication. Besides, the communicator 110 may further include a mobile communication module connected to a mobile communication network according to various mobile communication standards, such as 3rd generation (3G), 3rd generation partnership project (3GPP), long term evolution (LTE), and the like to perform communication. Further, the communicator 110 may also include at least one of wired communication modules (not illustrated), such as high-definition multimedia interface (HDMI), universal serial bus (USB), IEEE 1394, RS-232, and the like.

The storage 130 stores various programs and data for operating the electronic apparatus 100. More particularly, information on the owner terminal apparatus 300 having the approval authority for the control of the electronic apparatus 100 may be stored in the storage 130 in advance. Here, the information on the owner terminal apparatus 300, which is identification information of the owner terminal apparatus 300, may include at least one of a media access control (MAC) address, a serial number, and a model number of the owner terminal apparatus 300, and a name of the owner, who is an owner of the owner terminal apparatus 300.

Further, the storage 130 may store authentication information for control authority authentication for the electronic apparatus 100 of the guest terminal apparatus 200. As will be described below, in a case in which the authentication information transmitted together with the control command by the guest terminal apparatus 200 is matched to the authentication information stored in the storage 130, since the electronic apparatus 100 performs an operation according to the control command transmitted by the guest terminal apparatus 200, the guest terminal apparatus 200 may control the electronic apparatus 100 by using the authentication information provided from the electronic apparatus 100.

In this case, the authentication information stored in the storage 130 may include at least one of information on the guest terminal apparatus 200 requesting the control authority, information on the owner terminal apparatus 300 approving the control authority request, and information on the approved control authority, but is not limited thereto. Diverse embodiments and more detailed contents of the authentication information will be described below.

Further, according to an embodiment of the present disclosure, the storage 130 may store a list of the owner terminal apparatuses having the approval authority for the control of the electronic apparatus 100. For example, since the owner terminal apparatus 300 having the approval authority for the control of the electronic apparatus 100 need not necessarily be one, the storage 130 may store information on at least one owner terminal apparatus 300 having the approval authority for the control of the electronic apparatus 100.

Further, as will be described below, according to an embodiment of the present disclosure, the guest may also select a function for acquiring the control authority among a plurality of functions that may be performed in the electronic apparatus 100 through the guest terminal apparatus 200. Therefore, as the premise thereof, the electronic apparatus 100 may store information (in other words, resource information) about a plurality of functions that may be performed in the storage 130, and transmit it to the guest terminal apparatus 200 in response to the request of the guest terminal apparatus 200.

To this end, the storage 130 may be implemented in random access memory (RAM), read only memory (ROM), a flash memory, a hard disk drive (HDD), a solid state drive (SSD), and the like.

The processor 120 controls an overall operation of the electronic apparatus 100. More particularly, when the processor 120 receives the control authority request from the guest terminal apparatus 200, the processor 120 may control the communicator 110 to transmit the approval request for the control authority request of the guest terminal apparatus 200 to the owner terminal apparatus 300.

Here, the control authority request received from the guest terminal apparatus 200 may also be an authority request for controlling all functions that may be performed in the electronic apparatus 100, and may also be an authority request for controlling some functions of the plurality of functions that may be performed in the electronic apparatus 100.

Further, the approval request transmitted to the owner terminal apparatus 300 may include information on the guest terminal apparatus 200 requesting the control authority, information on the control authority requested by the guest terminal apparatus 200, and information on the electronic apparatus 100 to which the control authority is requested.

Here, the information on the guest terminal apparatus 200, which is identification information of the guest terminal apparatus 200, may include at least one of an MAC address, a serial number, and a model number of the guest terminal apparatus 200, and a name of the guest, who is an owner of the guest terminal apparatus 200. Further, the information on the control authority requested by the guest terminal apparatus 200 may include information on the function of the electronic apparatus 100 to which the guest terminal apparatus 200 requests the control authority. Further, the information on the electronic apparatus 100 to which the control authority is requested, which is identification information of the electronic apparatus 100, may include at least one of an MAC address, a serial number, and a model number of the electronic apparatus 100, and a name of the electronic apparatus 100.

Here, the information on the guest terminal apparatus 200 and the information on the control authority requested by the guest terminal apparatus 200 may be acquired in a process in which the guest terminal apparatus 200 requests the control authority to the electronic apparatus 100, and the information on the electronic apparatus 100 may be stored in the storage 130 in advance. However, the information is not limited thereto.

Meanwhile, according to an embodiment of the present disclosure, the guest terminal apparatus 200 may retrieve one or more electronic apparatuses existing around the guest terminal apparatus 200 to which the control authority is requested according to an operation of the guest, and may request the control authority to one electronic apparatus 100 selected according to the operation of the guest among the one or more retrieved electronic apparatuses. Accordingly, when the control authority request is received from the guest terminal apparatus 200 through the communicator 110, the processor 120 may control the communicator 110 to transmit the approval request for the requested control authority to the owner terminal apparatus 300.

Here, according to an embodiment of the present disclosure, the processor 120 may transmit information on the plurality of functions that may be performed in the electronic apparatus 100 to the guest terminal apparatus 200 in response to the electronic apparatus retrieval of the guest terminal apparatus 200. For example, according to an embodiment of the present disclosure, the guest terminal apparatus 200 may request the electronic apparatus 100 to transmit the information on the plurality of functions that may be performed in the electronic apparatus 100 in the process of retrieving the electronic apparatus, and the processor 120 may control the communicator 110 to transmit the information on the plurality of functions that may be performed in the electronic apparatus 100 to the guest terminal apparatus 200 in response to the request. Accordingly, the guest terminal apparatus 200 may display the information on the retrieved electronic apparatus 100 and the plurality of functions that may be performed in the electronic apparatus 100, and when at least one function to be controlled among the plurality of functions is selected according to the operation of the guest, the guest terminal apparatus 200 may request the control authority for the at least one selected function to the electronic apparatus 100. In this case, when the control authority request for at least one function is received through the communicator 110, the processor 120 may control the communicator 110 to transmit the approval request for at least one function to which the control authority is requested to the owner terminal apparatus 300.

Further, according to another embodiment of the present disclosure, when the processor 120 receives the control authority request from the guest terminal apparatus, the processor 120 may also control the communicator 110 to transmit a list of the owner terminal apparatuses having the approval authority for the control of the electronic apparatus 100 to the guest terminal apparatus 200. Accordingly, the guest terminal apparatus 200 may receive and display the list of the owner terminal apparatuses, and when one owner terminal apparatus 300 is selected according to a selection of the guest from the displayed list of the owner terminal apparatuses, the guest terminal apparatus 200 may transmit information on the selected owner terminal apparatus 300 to the electronic apparatus 100. In this case, when the information on the selected owner terminal apparatus 300 is received through the communicator 110, the processor 120 may control the communicator 110 to transmit the approval request to the selected owner terminal apparatus 300.

As such, when the approval request for the control authority requested by the guest terminal apparatus 200 is transmitted to the owner terminal apparatus 300, the owner terminal apparatus 300 may display the approval request. As described above, since the approval request may include the information on the guest terminal apparatus 200 requesting the control authority, the information on the control authority requested by the guest terminal apparatus 200, and the information on the electronic apparatus 100 to which the control authority is requested, the owner who owns the owner terminal apparatus 300 may know who has requested the control authority for a certain function of a certain electronic apparatus 100 and may approve the approval request by operating the owner terminal apparatus 300.

Accordingly, when an approval for the approval request is received from the owner terminal apparatus 300 through the communicator 110, the processor 120 may generate and store authentication information for the control authority authentication for the electronic apparatus 100 of the guest terminal apparatus 200 and transmit the generated authentication information to the guest terminal apparatus 200. Accordingly, since the guest terminal apparatus 200 may control the electronic apparatus 100 by using the authentication information received from the electronic apparatus 100, the authentication information is a kind of authentication key that allows the guest terminal apparatus 200 to control the electronic apparatus 100.

For example, the processor 120 may generate the information on the owner terminal apparatus 300 approving the approval request and the information on the control authority approved by the owner terminal apparatus 300 as the authentication information and store it in the storage 130. Further, the processor 120 may generate the authentication information by matching the information on the owner terminal apparatus 300 approving the approval request and the information on the control authority approved by the owner terminal apparatus 300 to the information on the guest terminal apparatus 200 requesting the control authority, and may also store it in the storage 130.

Here, the information on the control authority approved by the owner terminal apparatus 300 may include information on at least some functions of the functions of the electronic apparatus 100 to which the guest terminal apparatus 200 requests the control authority. For example, in a case in which the control authority request of the guest terminal apparatus 200 is approved by the owner terminal apparatus 300 as it is, the information on the approved control authority may include information on all functions to which the guest terminal apparatus 200 requests the control authority, and in a case in which only a portion of the control authority request of the guest terminal apparatus 200 is approved by the owner terminal apparatus 300, the information on the approved control authority may include only information on the some approved functions of the functions of the electronic apparatus 100 to which the guest terminal apparatus 200 requests the control authority.

Meanwhile, the processor 120 may transmit the generated authentication information to the guest terminal apparatus 200. Here, the authentication information transmitted to the guest terminal apparatus 200 does not necessarily need to be exactly the same as the authentication information stored in the storage 130.

For example, according to an embodiment of the present disclosure, the processor 120 may generate the authentication information for the control authority authentication of the guest terminal apparatus 200 and store it in the storage 130, and may also separately generate authentication information that the guest terminal apparatus 200 may control the electronic apparatus 100 and transmit it to the guest terminal apparatus 200. For example, the processor 120 may encode the information on the owner terminal apparatus 300 approving the approval request, the information on the control authority approved by the owner terminal apparatus 300, and the information on the electronic apparatus 100 in a variety of manners to generate the authentication information and transmit it to the guest terminal apparatus 200.

Accordingly, the guest terminal apparatus 200 may store the authentication information received from the electronic apparatus 100 and then control the function of the electronic apparatus 100 by using the stored authentication information.

Meanwhile, according to an embodiment of the present disclosure, the guest terminal apparatus 200 may also generate and store the authentication information for controlling the electronic apparatus 100 by using the information received from the electronic apparatus 100. For example, when the information on the owner terminal apparatus 300 approving the approval request and the information on the approved control authority are received from the electronic apparatus 100, the guest terminal apparatus 200 may also generate and store the authentication information by matching the received information to the information on the electronic apparatus 100.

Meanwhile, according to an embodiment of the present disclosure, the user interface (UI) capable of controlling the electronic apparatus 100 may be displayed on the guest terminal apparatus 200, and the guest may input a control command for controlling the function of the electronic apparatus 100 through the displayed UI. Here, the UI capable of controlling the electronic apparatus 100 may be displayed by executing an application which is installed in the guest terminal apparatus 200 in advance or connecting the guest terminal apparatus 200 to a server (not illustrated) providing the UI.

Therefore, when the control command of the guest for controlling the electronic apparatus 100 is input to the guest terminal apparatus 200 through the UI, the guest terminal apparatus 200 may transmit the stored authentication information together with the control command for controlling the electronic apparatus 100 to the electronic apparatus 100.

Accordingly, when the authentication information and the control command are received through the communicator 110, the processor 120 may match the received authentication information and the authentication information stored in the storage 130 to each other to determine whether the control command is performed.

For example, in a case in which the information on the owner terminal apparatus 300 approving the approval request and the information on the approved control authority which are included in two authentication information coincide with each other and the received control command is a control command for the function included in the information on the approved control authority, the processor 120 may determine that the two authentication information are matched to each other, and may determine that the two authentication information are not matched to each other, otherwise.

Therefore, when the received authentication information and the stored authentication information are matched to each other, the processor 120 may perform the control command and then transmit a performance result message to the guest terminal apparatus 200, and when the received authentication information and the stored authentication information are not matched to each other, the processor 120 may control the communicator 110 to transmit a message informing that the guest terminal apparatus 200 does not have authority for controlling the electronic apparatus 100 to the guest terminal apparatus 200.

Meanwhile, according to an embodiment of the present disclosure, the authentication information may include information on an expiration time of the control authority for the electronic apparatus 100 of the guest terminal apparatus 200. As described above, when the approval request is received from the electronic apparatus 100, the owner terminal apparatus 300 may display the approval request.

Here, according to an embodiment of the present disclosure, the owner may approve the approval request by adding the expiration time to the control authority for which the approval is requested. Specifically, the owner terminal apparatus 300 may display the UI capable of setting the expiration time together with a variety of information included in the approval request, and the owner may set the expiration time through the UI to approve the approval request. The expiration time may be set so that the control authority is valid for a predetermined time from a time at which the owner approves the approval request, or may also be set in a manner of directly inputting a start point of time and an end point of time of the a valid time.

Accordingly, the owner terminal apparatus 300 may transmit information on the expiration time together with the approval for the approval request to the electronic apparatus 100. When the information on the expiration time together with the approval for the approval request is received through the communicator 110, the processor 120 may generate authentication information to which the expiration time is added and store it in the storage 130, and may control the communicator 110 to transmit it to the guest terminal apparatus 200.

The guest terminal apparatus 200 receiving the authentication information to which the expiration time is added may control the electronic apparatus 100 by using the authentication information until the expiration time elapses, but may not control the electronic apparatus 100 after the expiration time elapses.

For example, when the control command together with the authentication information including the expiration time is received from the guest terminal apparatus 200, the processor 120 may determine whether the expiration time elapses and may not perform an operation according to the control command when the expiration time elapses. To this end, the processor 120 may also delete the authentication information stored in the storage 130 when the expiration time included in the authentication information elapses, and may also not perform only the control command while not deleting the authentication information.

Here, the processor 120 may not perform the operation according to the control command when the control command is received from the guest terminal apparatus 200 after the expiration time elapses, and the processor 120 may stop the operation which was performed when the expiration time elapses, even in a case in which the processor 120 receives the control command from the guest terminal apparatus 200 before the expiration time elapses and is in operation according to the received control command.

Meanwhile, according to an embodiment of the present disclosure, the authentication information may be integrated authentication information in which a plurality of authentication information are integrated. Specifically, the guest terminal apparatus 200 may receive authentication information on the plurality of electronic apparatuses from the respective electronic apparatuses, and the authentication information received from the respective electronic apparatuses may be integrated and managed in a one file or one authentication information form.

For example, the guest terminal apparatus 200 may each receive first and second authentication information capable of controlling the respective apparatuses from a first electronic apparatus of a first owner and a second electronic apparatus of a second owner. The guest terminal apparatus 200 may separately store and manage the first authentication information and the second authentication information, but may also store and manage the first authentication information and the second authentication information as the integrated information as described above.

In a case in which the guest performs an operation for controlling the first electronic apparatus through the guest terminal apparatus 200, the guest terminal apparatus 200 may transmit the integrated authentication information together with the control command for controlling a function of the first electronic apparatus to the first electronic apparatus, and a processor of the first electronic apparatus receiving the integrated authentication information together with the control command may match the received integrated authentication information and the stored authentication information to each other to determine whether the control command is performed. Specifically, the processor of the first electronic apparatus may determine whether the stored authentication information is included in the received integrated authentication information to determine whether the control command is performed. For example, in a case in which the stored authentication information is included in the received integrated authentication information, the processor of the first electronic apparatus may perform an operation of the control command, and in a case in which the stored authentication information is not included in the received integrated authentication information, the processor of the first electronic apparatus may not perform the operation of the control command.

The second electronic apparatus may also operate in the same manner as those described above.

Meanwhile, the integrated authentication information may include at least two or more of authentication information capable of controlling at least one function of a plurality of functions that may be performed in the electronic apparatus 100, authentication information capable of controlling a function different from at least one function of the plurality of functions that may be performed in the electronic apparatus 100, and authentication information capable of controlling another electronic apparatus. For example, the guest terminal apparatus 200 may generate and manage the integrated authentication information in a case in which different authentication information capable of controlling the respective electronic apparatuses are received from different electronic apparatuses as described above as well as a case in which the authentication information on different functions of the plurality of functions that may be performed in the electronic apparatus are each received even in the same electronic apparatus. For example, after control authority for a first function of the electronic apparatus 100 is approved by the owner terminal apparatus 300 and the first authentication information is received from the electronic apparatus 100, when the second authentication information for a second function of the same electronic apparatus 100 is received from the electronic apparatus 100, the guest terminal apparatus 200 may integrate the first and second authentication information and manage it as one authentication information.

The guest terminal apparatus 200 may also integrate and manage the first and second authentication information received from the first and second electronic apparatuses described above, and the first and second authentication information received from the electronic apparatus 100 into one authentication information.

Meanwhile, according to an embodiment of the present disclosure, the guest terminal apparatus 200 may request the control authority for the plurality of electronic apparatuses to the respective electronic apparatuses, and may receive the respective authentication information from the respective electronic apparatuses 100 when the respective owner terminal apparatuses having approval authority for the control of the respective electronic apparatuses approve the control authority request.

Here, in a case in which the owner terminal apparatuses 300 having the approval authority for the control of the respective electronic apparatuses are the same as each other, one electronic apparatus of the plurality of electronic apparatuses may be approved with the control authority request of the guest terminal apparatus 200 for the other electronic apparatus and generate authentication information to transmit it to the guest terminal apparatus 200.

For example, in a case in which the guest terminal apparatus 200 requests the control authority to the respective electronic apparatuses to control the plurality of electronic apparatuses, the respective electronic apparatuses may transmit information on the owner terminal apparatus having the approval authority for own control to the guest terminal apparatus 200.

Here, in a case in which the information on the owner terminal apparatus received from the plurality of electronic apparatuses are the same, that is, in a case in which the plurality of electronic apparatuses have the same owner terminal apparatus 300, the guest terminal apparatus 200 may select one electronic apparatus 100 of the plurality of electronic apparatuses and transmit information on the control authority requested to different electronic apparatuses to the selected electronic apparatus 100.

Here, the guest terminal apparatus 200 may select the electronic apparatus based on specification information of the plurality of electronic apparatuses. Specifically, according to an embodiment of the present disclosure, in response to the control authority request of the guest terminal apparatus 200, the respective electronic apparatuses may transmit specification information of the electronic apparatus including at least one of the type of power supply of the electronic apparatus, memory capacity, a communication manner, and a processor speed to the guest terminal apparatus 200.

Accordingly, the guest terminal apparatus 200 may select the electronic apparatus 100 having highest specification based on the specification information received from the respective electronic apparatuses. For example, the guest terminal apparatus 200 may determine that the specification of the electronic apparatus which is supplied with constant power through a wire is higher than that of the electronic apparatus supplied with the power through a battery. Further, the guest terminal apparatus 200 may determine that the specification of the electronic apparatus is higher, as the memory capacity is large and the processor speed is fast. Further, the guest terminal apparatus 200 may determine the electronic apparatus using a communication manner capable of transmitting and receiving a more amount of data at the same time as the electronic apparatus having the higher specification. According to an embodiment of the present disclosure, the electronic apparatus having the highest score may be selected as the electronic apparatus having the highest specification by giving a score for each of types of specification and summing the scores, but is not limited thereto.

As such, in a case in which one electronic apparatus 100 of the plurality of electronic apparatuses is selected, the guest terminal apparatus 200 may transmit the information on the control authority requested to different electronic apparatuses to the selected electronic apparatus 100.

Accordingly, when the information on the control authority requested to the different electronic apparatuses by the guest terminal apparatus 200 is received from the guest terminal apparatus 200 through the communicator 110, the processor 120 may transmit the control authority requested to oneself (electronic apparatus 100) and the approval request for the respective control authorities requested to different electronic apparatuses by the guest terminal apparatus 200 to the owner terminal apparatus 300.

When an approval for the respective control authorities is received from the owner terminal apparatus 300, the processor 120 may generate authentication information for the control authority authentication for the electronic apparatus 100 of the guest terminal apparatus 200 and different electronic apparatuses to store it in the storage 130, and transmit the generated authentication information to the guest terminal apparatus 200.

Here, the processor 120 may generate the authentication information on the electronic apparatus 100 and store it in the storage 130, and may only generate the authentication information on different electronic apparatuses and not store it in the storage 130. As such, the generated authentication information may be transmitted to the guest terminal apparatus 200. Here, the processor 120 may also transmit the authentication information on the electronic apparatus 100 and the authentication information on the different electronic apparatus to the guest terminal apparatus 200, and may also integrate two authentication information into one authentication information to transmit it to the guest terminal apparatus 200 in an integrated authentication information form.

Accordingly, the guest terminal apparatus 200 may control the electronic apparatus 100 as well as the different electronic apparatuses by using the authentication information received from the electronic apparatus 100.

To this end, the processor 120 may include one or more of a central processing unit (CPU), an application processor (AP), a communication processor (CP), or an advanced reduced instruction set computer (RISC) machines (ARM) processor.

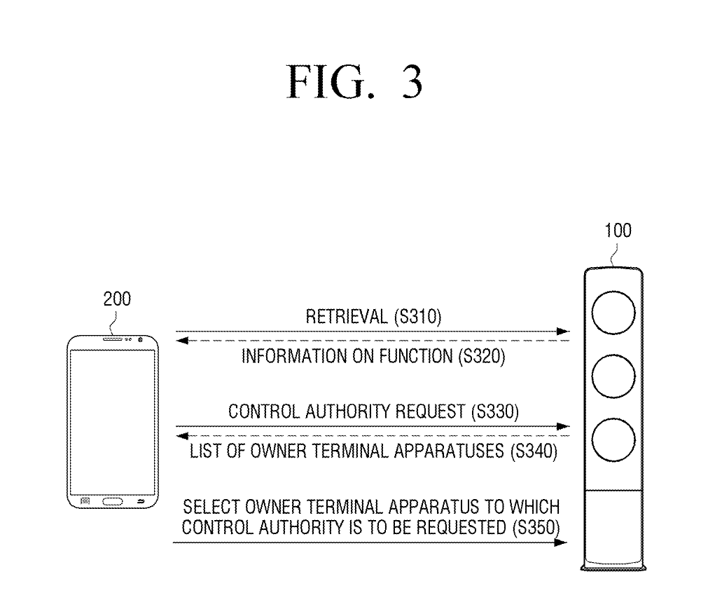

Hereinafter, an operation of the control authority authentication and processing system according to diverse embodiments of the present disclosure will be described with reference to FIGS. 3 to 9. Meanwhile, all of the operations illustrated in FIGS. 3 to 8 are not necessarily required, and some operations may be omitted or the order thereof may be changed. FIGS. 3 to 5 illustrate an example in which the son requests the control authority for the air conditioner 100 to the father who has the owner terminal apparatus 300 by using the guest terminal apparatus 200.

FIG. 3 is an illustrative diagram illustrating a process of requesting, by a guest terminal apparatus, control authority for an electronic apparatus according to an embodiment of the present disclosure.

Referring to FIG. 3, the guest terminal apparatus 200 may retrieve the electronic apparatus 100 therearound to control the electronic apparatus 100. Here, the guest terminal apparatus 200 may request the electronic apparatus 100 to transmit information on at least one function which may be performed in the electronic apparatus 100 at operation S310.

In response to the request, the electronic apparatus 100 may transmit information on the plurality of functions which may be performed in the electronic apparatus 100 to the guest terminal apparatus 200 at operation S320. Here, the plurality of functions which may be performed in the electronic apparatus 100 may be different for each of types of the electronic apparatuses 100, including power on/off of the electronic apparatus 100. As illustrated in FIG. 3, in a case in which the electronic apparatus 100 is an air conditioner, the information on the plurality of functions which may be performed in the electronic apparatus 100 may include power on/off of the air conditioner 100, a temperature control thereof, a wind direction control thereof, and the like. If the electronic apparatus 100 is a TV, the information on the functions which may be performed in the electronic apparatus 100 may include power on/off of the TV, a channel change thereof, a volume control thereof, an input source change thereof, and the like, but is not limited thereto.

When the guest terminal apparatus 200 receives the information on the plurality of functions which may be performed in the electronic apparatus 100, it may display the received information. Accordingly, the guest may select a function to be controlled by himself, that is, a function for requesting the control authority among the plurality of displayed functions. Meanwhile, in a case in which the plurality of electronic apparatuses are retrieved around the guest terminal apparatus 200, the guest terminal apparatus 200 may display a function list for each of the electronic apparatuses, the guest may select an electronic apparatus for requesting the control authority and at least one function of the plurality of functions of the corresponding electronic apparatus, and the guest terminal apparatus 200 may request the control authority for the selected function of the selected electronic apparatus 100 to the selected electronic apparatus 100 at operation S330.

Meanwhile, as described above, there may be a plurality of owner terminal apparatuses 300 having the approval authority for the control of the electronic apparatus 100, and the electronic apparatus 100 may transmit a list of the owner terminal apparatuses to the guest terminal apparatus 200 in response to the control authority request of the guest terminal apparatus 200 at operation S340.

Accordingly, the guest terminal apparatus 200 may display the list of the owner terminal apparatuses having the approval authority for the control of the electronic apparatus 100, and the guest may select the owner terminal apparatus 300 for requesting the control authority from the displayed list of the owner terminal apparatuses at operation S350. Accordingly, the guest terminal apparatus 200 may transmit information selection information on the selected owner terminal apparatus 300 to the electronic apparatus 100.

Accordingly, the electronic apparatus 100 may request the approval of the control authority requested to the selected owner terminal apparatus 300, and generate the authentication information to issue it to the guest terminal apparatus 200, accordingly.

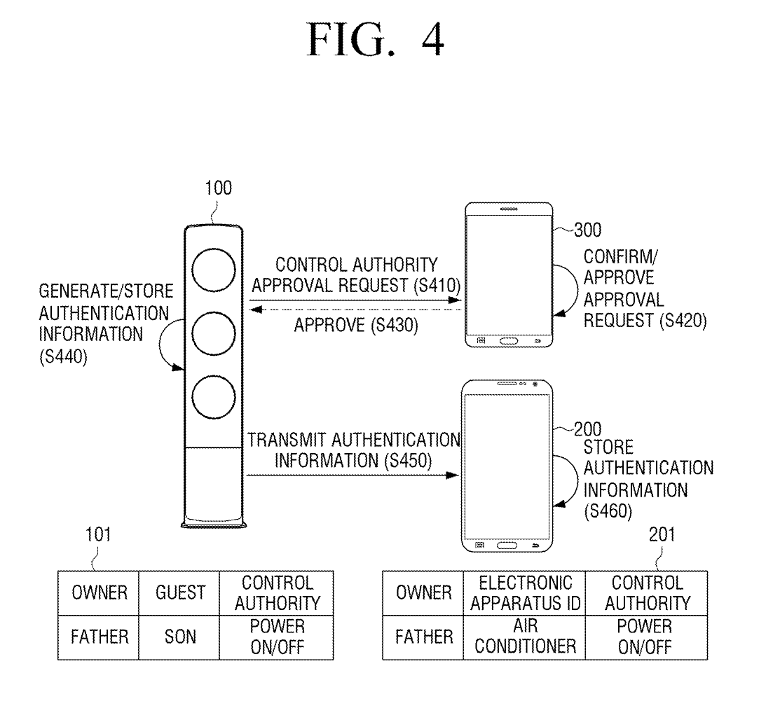

FIG. 4 is an illustrative diagram illustrating a process of generating, by an electronic apparatus, authentication information and transmitting it to a guest terminal apparatus according to an embodiment of the present disclosure.

Referring to FIG. 4, if the control authority request or the selection information on the owner terminal apparatus 300 is received from the guest terminal apparatus 200, the electronic apparatus 100 may transmit the approval request for the requested control authority to the selected owner terminal apparatus 300 at operation S410. Here, the approval request may include information on the guest terminal apparatus 200 requesting the control authority, information on the control authority requested by the guest terminal apparatus 200, and information on the electronic apparatus 100 to which the control authority is requested.

Accordingly, the owner terminal apparatus 300 may display a variety of information included in the approval request, and the owner may confirm who has requested the control authority for a certain function of a certain electronic apparatus 100 owned by the owner through the owner terminal apparatus 300 and approve the approval request at operation S420. The owner may also disapprove the approval request.

If the owner approves the approval request, the owner terminal apparatus 300 transmits information representing that the approval request has been approved to the electronic apparatus 100 at operation S430, and the electronic apparatus 100 generates and stores the authentication information for the control authority authentication of the guest terminal apparatus 200 at operation S440. Specifically, the electronic apparatus 100 may generate the authentication information by matching the information on the owner terminal apparatus 300 approving the approval request and the information on the control authority approved by the owner terminal apparatus 300 to the information on the guest terminal apparatus 200 requesting the control authority, and may store it in the storage 130.

Reference numeral 101 denotes one example of the authentication information stored in the electronic apparatus 100. For example, in the example of FIG. 4, it may be seen that the son, who is the guest, has requested the control authority for the air conditioner 100, the father, who is the owner, has approved the approval request for the control authority, and information that the approved control authority is a power on/off function of the air conditioner 100 is stored as the authentication information.

Accordingly, the electronic apparatus 100 may transmit the generated authentication information to the guest terminal apparatus 200 at operation S450, and the guest terminal apparatus 200 may receive and store the authentication information at operation S460. Here, the electronic apparatus 100 may also transmit the authentication information stored in the storage 130 to the guest terminal apparatus 200 as it is, and may also separately generate authentication information that the guest terminal apparatus 200 may control the electronic apparatus 100 and transmit it to the guest terminal apparatus 200.

In the case in which the authentication information is separately generated, the electronic apparatus 100 may encode the information on the owner terminal apparatus 300 approving the approval request, the information on the control authority approved by the owner terminal apparatus 300, and the information on the electronic apparatus 100 in a variety of manners and transmit it to the guest terminal apparatus 200.

If the electronic apparatus 100 transmits the authentication information as in reference numeral 101 as it is or transmits only the information on the owner terminal apparatus and the information on the control authority to the guest terminal apparatus 200, the guest terminal apparatus 200 may also store the authentication information by matching the information on the electronic apparatus 100 to the information received from the electronic apparatus 100.

Reference numeral 201 denotes one example of the authentication information stored in the guest terminal apparatus 200. For example, it may be seen that the owner approving the approval request is the father, the electronic apparatus 100 that the control authority is approved is the air conditioner 100, and information that the authority is the power on/off of the air conditioner 100 is stored as the authentication information.

The guest terminal apparatus 200 may control the electronic apparatus 100 by using the above-mentioned stored authentication information.

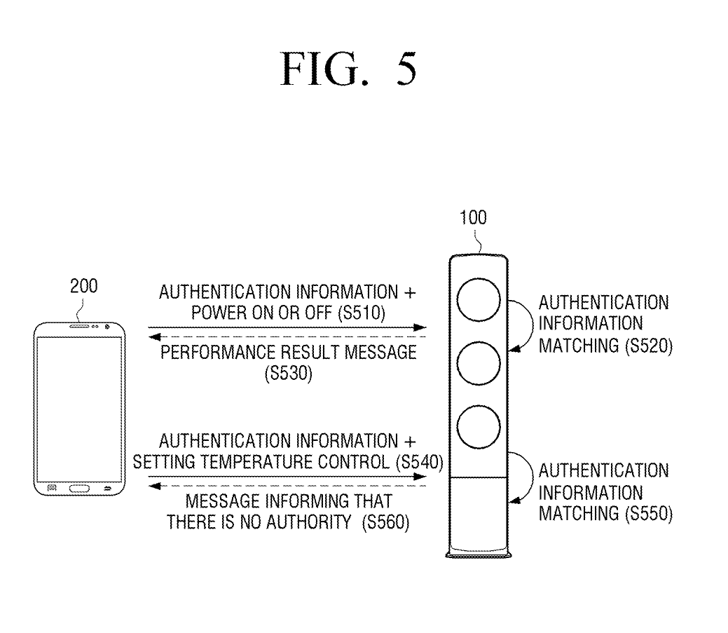

FIG. 5 is an illustrative diagram illustrating a process of controlling, by a guest terminal apparatus, an electronic apparatus according to an embodiment of the present disclosure. In FIG. 5, the electronic apparatus 100 and the guest terminal apparatus 200 each store the authentication information 101 and 201 as illustrated in the example of FIG. 4.

Referring to FIG. 5, the guest terminal apparatus 200 transmits the stored authentication information together with a control command of turning on or off the power supply of the electronic apparatus 100 to the electronic apparatus 100 at operation S510. Accordingly, the electronic apparatus 100 may match the authentication information received from the guest terminal apparatus 200 and the authentication information stored in the storage 130 to each other at operation S520, and may determine whether the control command, such as the power on or off received from the guest terminal apparatus 200 is performed according to the matching result.

Specifically, since the information on the electronic apparatus 100 included in the received authentication information coincides with the information on the electronic apparatus 100, the information on the owner terminal apparatus 300 approving the approval request and the information on the approved control authority, which are included in two authentication information 101 and 201, coincide with each other, and the received control command is a control command for the function (power on or off) included in the information on the approved control authority, the electronic apparatus 100 may determine that the two authentication information are matched to each other, perform the control command, and then transmit the performance result message to the guest terminal apparatus 200 at operation S530.

Meanwhile, if the guest terminal apparatus 200 transmits the stored authentication information together with a control command controlling a setting temperature of the electronic apparatus 100 to the electronic apparatus at operation S540, the electronic apparatus 100 may also match the authentication information received from the guest terminal apparatus 200 and the authentication information stored in the storage 130 to each other at operation S550 and determine whether the control command is performed according to the matching result.

Specifically, since the information on the electronic apparatus 100 included in the received authentication information coincides with the information on the electronic apparatus 100, the information on the owner terminal apparatus 300 approving the approval request and the information on the approved control authority, which are included in two authentication information 101 and 201, coincide with each other, but the received control command (the setting temperature control) is not a control command for the function (power on or off) included in the information on the approved control authority, the electronic apparatus 100 may determine that the two authentication information are not matched to each other and transmit a message informing that the guest terminal apparatus 200 does not have authority for controlling the setting temperature of the electronic apparatus 100 to the guest terminal apparatus 200 at operation S560.

Meanwhile, hereinabove, the order or the process of matching the authentication information and the control command received from the guest terminal apparatus 200 to the stored authentication information by the electronic apparatus 100 is not limited to the above example. For example, the matching order of each information may be changed at any time, and some operations may be omitted or other additional operations may be added. If the information on the electronic apparatus included in the received authentication information is not the information on the electronic apparatus, or the received control command is not related to the function included in the information on the approved control authority, the electronic apparatus 100 may also immediately transmit a message informing that there is no authority to the guest terminal apparatus 200.

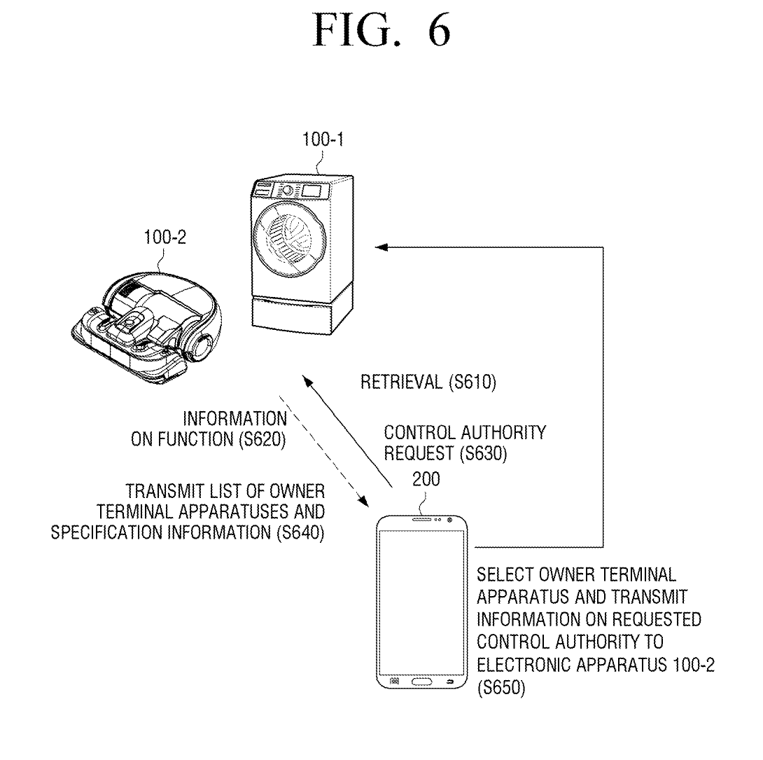

Meanwhile, according to an embodiment of the present disclosure, the guest terminal apparatus 200 may also obtain the authentication information on the respective electronic apparatuses by requesting the control authority for the plurality of electronic apparatuses to the respective electronic apparatuses and receiving the approval for the control authority. This will be described with reference to FIGS. 6 to 8. FIGS. 6 to 8 illustrate examples in which the son requests control authorities for a washing machine 100-1 and a robot cleaner 100-2 to the father who owns the owner terminal apparatus 300 by using the guest terminal apparatus 200.

FIG. 6 is an illustrative diagram illustrating a process of requesting, by a guest terminal apparatus, control authority for a plurality of electronic apparatuses according to an embodiment of the present disclosure.

Referring to FIG. 6, the guest terminal apparatus 200 may retrieve the electronic apparatuses therearound and the functions of the respective electronic apparatuses at operation S610. In response to the retrieval, the washing machine 100-1 and the robot cleaner 100-2 around the guest terminal apparatus 200 may each transmit information on the plurality of functions which may be performed in the washing machine 100-1 and the robot cleaner 100-2 to the guest terminal apparatus 200 at operation S620.

The guest terminal apparatus 200 may display the information on the plurality of functions which may be performed in the respective devices for the washing machine 100-1 and the robot cleaner 100-2 and transmit the control authorities for the washing machine 100-1 and the robot cleaner 100-2 to the respective apparatuses 100-1 and 100-2 according to the selection of the guest at operation S630.

Here, according to an embodiment of the present disclosure, each of the washing machine 100-1 and the robot cleaner 100-2 receiving the control authority request from the guest terminal apparatus 200 may transmit the list of the owner terminal apparatuses to the guest terminal apparatus 200. Accordingly, the guest may select the owner terminal apparatus for requesting the control authority from the list of the owner terminal apparatuses of the respective electronic apparatuses 100-1 and 100-2 displayed on the guest terminal apparatus 200, and transmit the selection information on the owner terminal apparatus to the respective electronic apparatuses 100-1 and 100-2. The respective electronic apparatuses 100-1 and 100-2 may transmit the approval request for the requested control authority to the respective owner terminal apparatuses selected by the guest. Accordingly, when the respective owner terminal apparatuses approve the control authority, the respective electronic apparatuses 100-1 and 100-2 may generate the authentication information and transmit it to the guest terminal apparatus 200, and the guest terminal apparatus 200 may each control the washing machine 100-1 and the robot cleaner 100-2 by using the authentication information received from the respective apparatuses 100-1 and 100-2. Here, according to an embodiment of the present disclosure, the guest terminal apparatus 200 may generate and manage the integrated authentication information by integrating the authentication information received from the respective electronic apparatuses 100-1 and 100-2, as described above.

Meanwhile, according to an embodiment of the present disclosure, the respective electronic apparatuses 100-1 and 100-2 may transmit specification information of the respective electronic apparatuses 100-1 and 100-2 when transmitting the list of the owner terminal apparatuses to the guest terminal apparatus 200, as illustrated in FIG. 6 at operation S640.

In this case, the guest terminal apparatus 200 may determine whether the owner terminal apparatuses of the respective electronic apparatuses 100-1 and 100-2 are the same. Here, the guest terminal apparatus 200 may determine that two electronic apparatuses 100-1 and 100-2 have the same owner terminal apparatus in a case in which the respective electronic apparatuses 100-1 and 100-2 have the same owner terminal apparatus as well as in a case in which there is the same owner terminal apparatus among the owner terminal apparatuses included in the list of the owner terminal apparatuses of the respective electronic apparatuses 100-1 and 100-2. In this case, according to an embodiment of the present disclosure, the guest terminal apparatus 200 may also automatically select the same owner terminal apparatus in the list of the respective owner terminal apparatuses as the owner terminal apparatus to which the approval request is to be transmitted.

As a result of the determination, in a case in which the owner terminal apparatuses of the washing machine 100-1 and the robot cleaner 100-2 are the same as the owner terminal apparatus 300, the guest terminal apparatus 200 may select one electronic apparatus for transmitting the approval request to the owner terminal apparatus 300 among the respective electronic apparatuses 100-1 and 100-2, based on the specification information received from the respective electronic apparatuses 100-1 and 100-2.

In the example of FIG. 6, for example, in a case in which the washing machine 100-1 has a specification that it uses constant power and is capable of Wi-Fi communication and the robot cleaner 100-2 has a specification that it uses a battery and it is capable of only Bluetooth communication, the guest terminal apparatus 200 may determine the washing machine 100-1 as the electronic apparatus having a higher specification and select the washing machine 100-1 among the washing machine 100-1 and the robot cleaner 100-2.

Accordingly, the guest terminal apparatus 200 may transmit information on the automatically or manually selected owner terminal apparatus 300 and information on the control authority requested to the robot cleaner 100-2 by the guest terminal apparatus 200 to the washing machine 100-1 at operation S650.

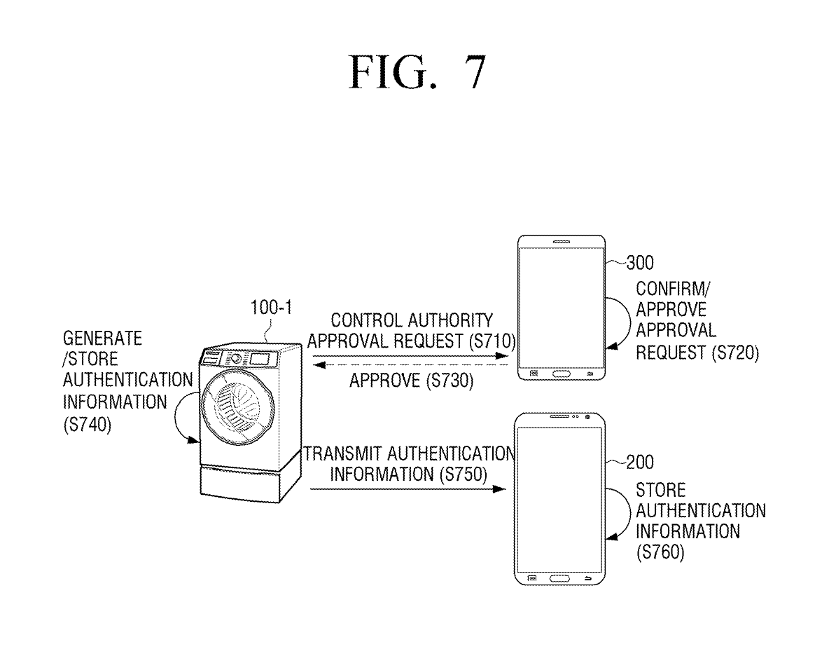

FIG. 7 is an illustrative diagram illustrating a process of generating, by an electronic apparatus, authentication information on a plurality of electronic apparatuses and transmitting it to a guest terminal apparatus according to an embodiment of the present disclosure.

Referring to FIG. 7, like the operation S650 of FIG. 6, the washing machine 100-1 receiving the information on the owner terminal apparatus 300 and the information on the control authority requested to the robot cleaner 100-2 by the guest terminal apparatus 200 may transmit the approval request for the control authority requested to the washing machine 100-1 and the control authority requested to the robot cleaner 100-2 by the guest terminal apparatus 200 to the owner terminal apparatus 300 at operation S710.

Accordingly, when the approval request is displayed on the owner terminal apparatus 300, the owner of the owner terminal apparatus 300 may confirm and approve the approval request at operation S720. If the approval request is approved, the owner terminal apparatus 300 may transmit an approval message for the approval request to the washing machine 100-1 at operation S730, and the washing machine 100-1 may generate and store authentication information for the control authority authentication for the washing machine 100-1 and the robot cleaner 100-2 of the guest terminal apparatus 200 at operation S740. Here, the washing machine 100-1 may generate and store the authentication information on the washing machine 100-1, and may merely generate the authentication information on the robot cleaner 100-2 and may not store it.

As such, the generated authentication information may be transmitted to the guest terminal apparatus 200 at operation S750. Here, the washing machine 100-1 may also each transmit the authentication information on the washing machine 100-1 and the authentication information on the robot cleaner 100-2 to the guest terminal apparatus 200, and may also integrate two authentication information into one authentication information to transmit it to the guest terminal apparatus 200. If the guest terminal apparatus 200 receives the authentication information from the washing machine 100-1, it may store the received authentication information at operation S760.

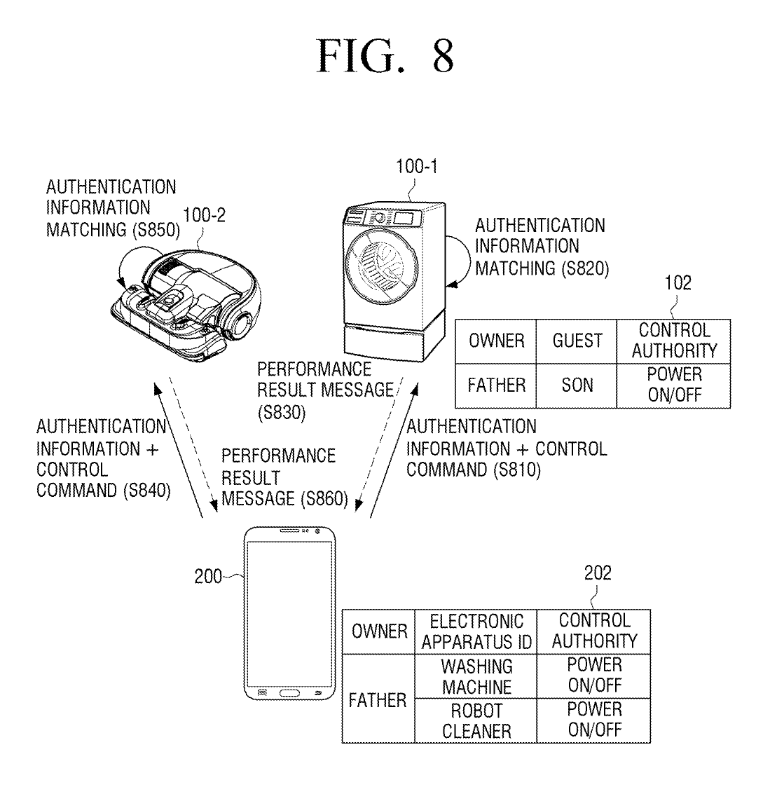

FIG. 8 is an illustrative diagram illustrating a process of controlling, by a guest terminal apparatus, a plurality of electronic apparatuses using authentication information according to an embodiment of the present disclosure.

Referring to FIG. 8, the guest terminal apparatus 200 receives and stores integrated authentication information like reference numeral 202 from the washing machine 100-1.

The guest terminal apparatus 200 may use the authentication information 202 to control the washing machine 100-1. Specifically, the guest terminal apparatus 200 may transmit the authentication information 202 together with a power on control command to the washing machine 100-1 to turn on the washing machine 100-1 at operation S810. The washing machine 100-1 may determine whether the power on control command is performed by matching the stored authentication information 102 to the received authentication information 202 at operation S820. Since both authentication information 102 and 202 are matched to each other, the washing machine 100-1 may turn on its own power and then transmit a performance result message of the control command to the guest terminal apparatus 200 at operation S830.

Meanwhile, the guest terminal apparatus 200 may use the authentication information 202 received from the washing machine 100-1 to control the robot cleaner 100-2. Actually, the authentication information 202 may also include the contents of the robot cleaner 100-2. The guest terminal apparatus 200 may transmit the authentication information 202 together with a power on control command to the robot cleaner 100-2 to turn on the robot cleaner 100-2 at operation S840.

Accordingly, the robot cleaner 100-2 may match the authentication information at operation S850, and when the authentication information are matched to each other, the robot cleaner 100-2 may turn on its own power and then transmit a performance result message of the control command to the guest terminal apparatus 200 at operation S860.

Here, since the robot cleaner 100-2 does not generate and store the authentication information, it does not store the authentication information to be matched to the authentication information 202 received from the guest terminal apparatus 200. In this case, the robot cleaner 100-2 performs verification of the authentication information by itself. For example, the robot cleaner 100-2 may compare the information on the owner terminal apparatus stored in the robot cleaner 100-2 and the information on the owner terminal apparatus included in the authentication information 202 received from the guest terminal apparatus 200 with each other, and may determine that the authentication information is verified when the information on the owner terminal apparatus 300 coincide with each other.

Accordingly, if the authentication information is verified, the robot cleaner 100-2 may perform the control command received together with the authentication information 202 and transmit the performance result message to the guest terminal apparatus 200. Meanwhile, after the authentication information 202 is verified as described above, the robot cleaner 100-2 may generate and store the authentication information by itself, or store the authentication information 202 received from the guest terminal apparatus 200, such that the control authority for the robot cleaner 100-2 of the guest terminal apparatus 200 may be authenticated later.

In the case of the examples of FIGS. 6 to 8, when requesting the control authority for the plurality of electronic apparatuses 100-1 and 100-2 having the same owner terminal apparatus 300, since the control authority for the remaining electronic apparatus 100-2 may be approved through the electronic apparatus 100-1 having a relatively better specification, the control authority may be effectively authenticated and managed without the server even in the IoT environment in which a plurality of low specification electronic apparatuses exist.

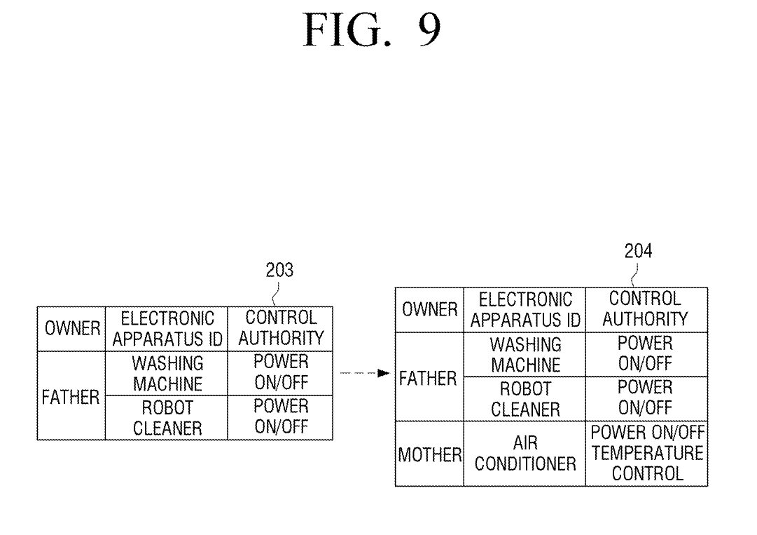

FIG. 9 is an illustrative diagram illustrating integrated authentication information which may be stored in a guest terminal apparatus according to an embodiment of the present disclosure.

Referring to FIG. 9, like the authentication information 203 of FIG. 9, the integrated authentication information is information in which authentication information of the plurality of apparatuses (the washing machine, the robot cleaner) are integrated. It may be seen from the authentication information 203 that the control authority for the power on/off of the washing machine and the power on/off of the robot cleaner is approved from the owner terminal apparatus that is owned by the father.

In a case in which the control authority for the power on/off of the air conditioner 100 is approved from the owner terminal apparatus that is owned by the mother and the authentication information is received from the air conditioner 100, the guest terminal apparatus 200 may generate and store integrated authentication information 204 by integrating the authentication information on the air conditioner 100 with the existing authentication information 203.

Meanwhile, the example of the integrated authentication information stored in the guest terminal apparatus 200 is not limited thereto. For example, in a case in which a control authority request for controlling the setting temperature of the air conditioner 100 is newly approved and is received from the air conditioner 100 in a state in which the authentication information 204 is stored, the guest terminal apparatus 200 may also integrate the newly received authentication information to the stored authentication information 204.

Meanwhile, the guest terminal apparatus 200 may also manage the authentication information for each of the owner terminal apparatuses or the owners. For example, as described above, in a case in which the authentication information is managed in one integrated authentication information form, when a size of the integrated authentication information is increased to a predetermined size or more, the guest terminal apparatus 200 may also manage the authentication information by dividing it for each of the owner terminal apparatuses or the owners. Meanwhile, the guest terminal apparatus 200 may also separately manage the plurality of authentication information without integrating the plurality of authentication information.

Accordingly, the control authority may be effectively authenticated and managed without a separate server.

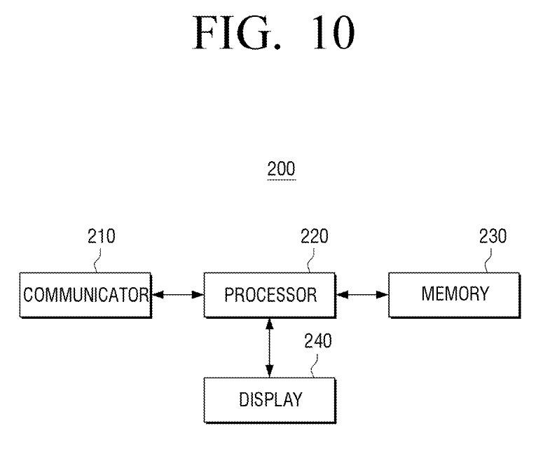

FIG. 10 is a block diagram of a user terminal apparatus according to an embodiment of the present disclosure. Here, a user terminal apparatus may be the guest terminal apparatus 200. In describing FIG. 10, a detail description of the operations overlapping with the operations of the guest terminal apparatus 200 described above will be omitted.

Referring to FIG. 10, the guest terminal apparatus 200 may include a communicator 210, a processor 220, a memory 230, and a display.

The communicator 210 may perform communication with the electronic apparatus 100 by a control of the processor 220 to transmit and receive a variety of information. More particularly, the communicator 210 may transmit the control authority request for the electronic apparatus to the electronic apparatus 100, and receive the authentication information for the control authority authentication for the electronic apparatus 100 of the guest terminal apparatus 200 from the electronic apparatus 100. Further, the communicator 210 may also transmit the control command and authentication information for controlling the electronic apparatus 100 to the electronic apparatus 100 according to an operation command of the guest. A variety of information transmitted and received between the guest terminal apparatus 200 and the electronic apparatus 100 described above may be transmitted and received through the communicator 210.

To this end, the communicator 210 may include at least one communication module of a local area wireless communication module (not illustrated), and a WLAN communication module (not illustrated). Here, the local area wireless communication module (not illustrated), which is a communication module wirelessly performing data communication with the electronic apparatus 100 located at a local area, may include, for example, a Bluetooth module, a ZigBee module, a NFC module, and the like. Further, the WLAN communication module (not illustrated) is a module connected to an external network according to a wireless communication protocol, such as Wi-Fi, IEEE, or the like, to perform communication. Besides, the communicator 110 may further include a mobile communication module connected to a mobile communication network according to various mobile communication standards, such as 3G, 3GPP, LTE, and the like to perform communication. Further, the communicator 110 may also include at least one of wired communication modules (not illustrated), such as HDMI, USB, IEEE 1394, RS-232, and the like.

The memory 230 stores various programs and data for operating the guest terminal apparatus 200. More particularly, the memory 230 may store the authentication information that the guest terminal apparatus 200 receives from the electronic apparatus 100. To this end, the memory 230 may be implemented in RAM, ROM, a flash memory, a HDD, a SSD, and the like.

The display 240 displays various images according to a control of the processor 220. More particularly, the display 240 may display a variety of UIs necessary for the operation of the guest terminal apparatus 200 described above. As such, through the displayed UI, the guest may see a variety of information and may input a necessary operation.

For example, the display 240 may display the electronic apparatuses retrieved around the guest terminal apparatus 200 and information on a plurality of functions which may be performed in the respective electronic apparatuses according to a control of the processor 220. Further, the display 240 may also display the list of the owner terminal apparatuses received from the electronic apparatus and may display the UI to which a control command may be input to control the electronic apparatus 100.

To this end, the display 140 may be implemented in various forms of displays, such as a liquid crystal display (LCD), organic light emitting diodes (OLED), an active-matrix organic light-emitting diode (AM-OLED), a plasma display panel (PDP), and the like. Here, the display 240 may also be implemented as a touch screen including a touch panel.

The processor 220 controls an overall operation of the guest terminal apparatus 200. More particularly, the processor 220 may perform a control so that the guest terminal apparatus 200 performs the operation of the guest terminal apparatus 200 in the description for the diverse embodiments described above. For example, since a detail description for the operation of the processor 220 is the same as the operation of the guest terminal apparatus 200 described above, the description thereof will be omitted.

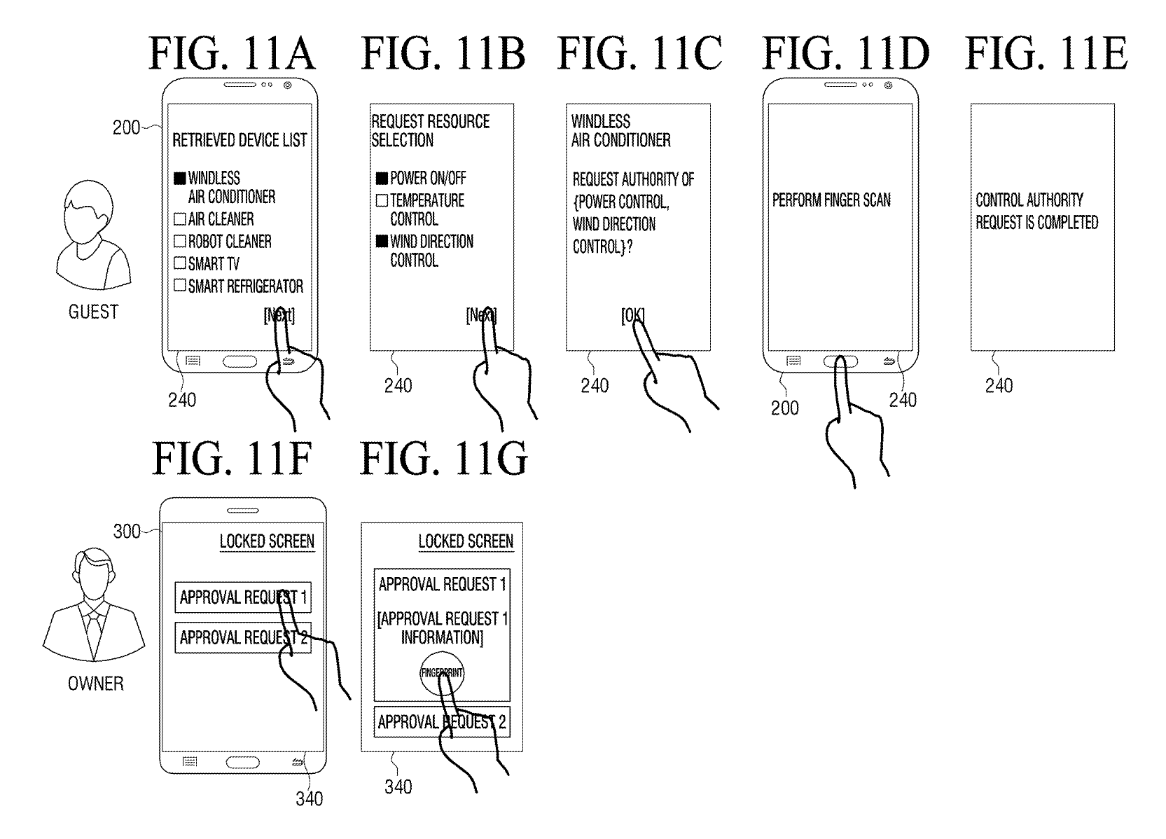

FIGS. 11A, 11B, 11C, 11D, 11E, 11F, and 11G are illustrative diagrams of UIs which may be displayed on a guest terminal apparatus and an owner terminal apparatus in a process of authenticating and processing control authority according to an embodiment of the present disclosure. FIGS. 11A, 11B, 11C, 11D, and 11E illustrate a display screen displayed on the display 240 of the guest terminal apparatus 200, and FIGS. 11F and 11G illustrate a screen displayed on a display 340 of the owner terminal apparatus 300.

Referring to FIGS. 11A, 11B, 11C, 11D, and 11E, the guest terminal apparatus 200 may retrieve electronic apparatuses therearound and display a retrieval result as illustrated in FIG. 11A. It may be seen from an example of FIG. 11A that five electronic apparatuses, such as a windless air conditioner 100, an air cleaner, a robot cleaner, a smart TV, and a smart refrigerator are retrieved.

When the guest selects the windless air conditioner 100 to obtain control authority for the windless air conditioner 100, the display 240 may display a screen selecting information on a plurality of functions which may be performed in the windless air conditioner 100, that is, a resource of the air conditioner 100 to which the control authority is to be requested, as illustrated in FIG. 11B. Accordingly, when the guest selects a power on/off function and a wind direction control function, the display 240 may display a UI asking whether control authority for power control and wind direction control are requested as illustrated in FIG. 11C. When the guest selects an OK button, the guest terminal apparatus 200 requests the control authority for the power on/off function and the wind direction control function of the windless air conditioner to the air conditioner 100.

Here, according to an embodiment of the present disclosure, in a case in which the guest terminal apparatus 200 includes a finger scan function, the guest terminal apparatus 200 may also display a UI allowing a finger scan to be performed, as illustrated in FIG. 11D, to finally confirm whether a person currently carrying the guest terminal apparatus 200 is the guest, and accordingly, when the finger scan is performed, the guest terminal apparatus 200 may transmit the control authority request for the air conditioner 100 and display a message informing that the control authority request is completed as illustrated in FIG. 11E.

FIG. 11F illustrates an approval request displayed on the owner terminal apparatus 300. Specifically, if the guest terminal apparatus 200 requests the control authority to the air conditioner 100, the air conditioner 100 transmits the approval request for the requested control authority to the owner terminal apparatus 300. Accordingly, the owner terminal apparatus 300 may display the approval request on the display 340 as illustrated in FIG. 11F.

Referring to FIG. 11F, it may be seen that two approval requests are currently received. The owner may see a variety of information included in the approval request by selecting the respective approval requests displayed on the display 340 of the owner terminal apparatus 300. FIG. 11G illustrates a case in which the owner selects an approval request 1 and information (e.g., information on the guest terminal apparatus 200 requesting the control authority, information on the control authority requested by the guest terminal apparatus 200, and information on the electronic apparatus 100 to which the control authority is requested) included in the approval request 1 is displayed.

Accordingly, the owner may confirm the content of the approval request and then determine whether the requested control authority is approved. Here, according to an embodiment of the present disclosure, as illustrated in FIGS. 11G and 11F, the above-mentioned approval process in the owner terminal apparatus 300 may be performed in a state in which the owner terminal apparatus 300 displays a locked screen. Further, in a case in which the owner terminal apparatus 300 has a finger scan function, the owner terminal apparatus 300 may immediately authenticate a fingerprint of the owner in the locked screen state. In this case, the owner may also approve the approval request by directly performing the finger scan in the state in which the owner terminal apparatus 300 is the locked screen.

Meanwhile, although FIGS. 11A, 11B, 11C, 11D, and 11E do not separately illustrate the contents in which the guest terminal apparatus receives and displays the list of the owner terminal apparatuses from the electronic apparatus, the guest terminal apparatus 200 may display the list of the owner terminal apparatuses and the approval request may be transmitted to the owner terminal apparatus selected by the guest from the list of the owner terminal apparatuses.

Further, although not illustrated in FIGS. 11G and 11F, according to an embodiment of the present disclosure, the owner terminal apparatus 300 may also approve the approval request as it is, but may also approve the approval request by adding a condition to the approval request.

Specifically, the owner may approve the approval request by adding an expiration time through the owner terminal apparatus 300. For example, when the son wants to view the TV for a predetermined time, the son may request TV viewing authority by using the guest terminal apparatus 200 owned by the son. In this case, the guest terminal apparatus 200 may transmit a control authority request to the TV, and the TV may transmit an approval request for the control authority request of the guest terminal apparatus 200 to the owner terminal apparatus 300 owned by the father. Accordingly, the father may approve the approval request by adding an expiration time condition through the owner terminal apparatus 300, and the TV receiving the approval to which the expiration time condition is added may generate and store authentication information to which the expiration time is added when the authentication information is generated and may transmit the authentication information to which the expiration time is added to the guest terminal apparatus 200. Therefore, the son may view the TV through the guest terminal apparatus 200 until the expiration time included in the authentication information elapses.

Further, according to an embodiment of the present disclosure, the owner terminal apparatus 300 may also approve the approval request by adding other conditions, not the expiration time to the control authority. In the above example, the father may also approve the approval request by adding a condition limiting the range of viewable channel of the son through the owner terminal apparatus 300.

As another example, in a case in which the son requests authority to use the refrigerator (e.g., authority to open the door of the refrigerator) and selects the owner to whom the authority is requested as the father, through the guest terminal apparatus 200, the refrigerator may transmit an approval request for refrigerator use authority of the son to the owner terminal apparatus 300 owned by the father. Here, the father may approve the approval request by adding the condition that a container in which alcohol is contained is kept locked in the refrigerator and only a door of a container in which alcohol is not contained is opened in the refrigerator through the owner terminal apparatus 300. Accordingly, when authentication information to which the above condition is added is transmitted to the guest terminal apparatus 200 from the refrigerator, the son may open the container in which alcohol is not contained by using the guest terminal apparatus 200.

Here, according to an embodiment of the present disclosure, in a case in which the guest terminal apparatus 200 and the refrigerator have an NFC communication function, the son may tag the guest terminal apparatus 200 with the refrigerator to open the door of the container in which alcohol is not contained. For example, in this case, with the tagging between the guest terminal apparatus 200 and the refrigerator, the authentication information together with a control command to open the door of the refrigerator may be transmitted to the refrigerator.

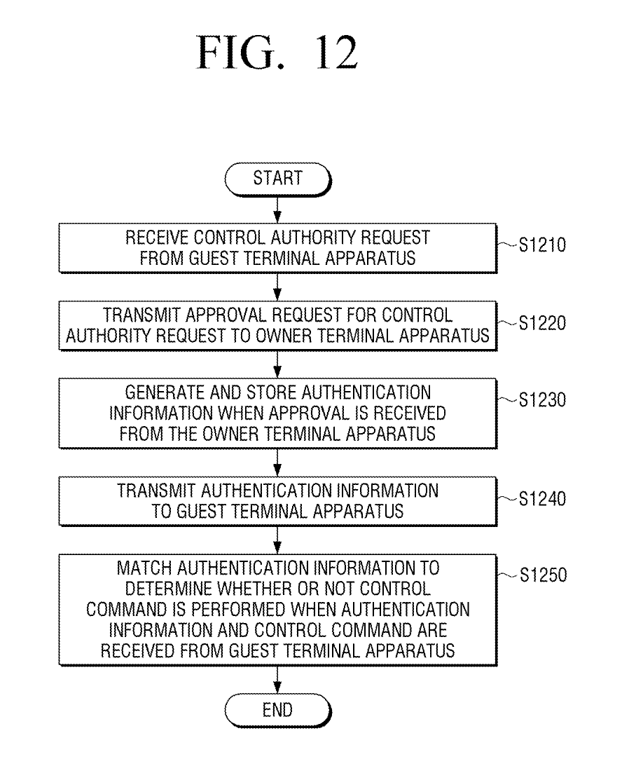

FIG. 12 is a flowchart illustrating a control authority authentication method of an electronic apparatus according to an embodiment of the present disclosure.

Referring to FIG. 12, the electronic apparatus 100 may receive the control authority request from the guest terminal apparatus 200 requesting the control authority for the electronic apparatus 100 at operation S1210, and accordingly, transmit the approval request for the control authority request to the owner terminal apparatus 300 having the approval authority for the control of the electronic apparatus 100 at operation S1220.

Specifically, according to an embodiment of the present disclosure, the electronic apparatus 100 may receive a request of information on a plurality of functions which may be performed in the electronic apparatus 100 from the guest terminal apparatus 200. Accordingly, the electronic apparatus 100 may transmit the information on the plurality of functions which may be performed in the electronic apparatus 100 to the guest terminal apparatus 200. Here, the request of the guest terminal apparatus 200 may be transmitted to the electronic apparatus 100 in the process of retrieving, by the guest terminal apparatus 200, the electronic apparatus 100 therearound. Accordingly, when at least one function of the plurality of functions which may be performed in the electronic apparatus 100 is selected by the guest terminal apparatus 200, the electronic apparatus 100 may receive the control authority request for the at least one selected function from the guest terminal apparatus 200.

Accordingly, the electronic apparatus 100 may transmit the approval request for the at least one function for which the control authority is requested to the owner terminal apparatus 300. Here, according to an embodiment of the present disclosure, the owner terminal apparatus 300 may also be selected by the guest from the guest terminal apparatus 200. For example, when the electronic apparatus 100 receives the control authority request from the guest terminal apparatus 200, it may transmit a list of the owner terminal apparatuses having the approval authority for the control of the electronic apparatus 100 to the guest terminal apparatus 200. Accordingly, when one owner terminal apparatus 300 of one or more owner terminal apparatuses included in the list of the owner terminal apparatuses is selected from the guest terminal apparatus, the electronic apparatus 100 may receive the information on the owner terminal apparatus 300 selected from the guest terminal apparatus 200. Accordingly, the electronic apparatus 100 may transmit the approval request to the selected owner terminal apparatus.

As such, if the transmitted approval request is approved by the owner terminal apparatus 300 and an approval is received from the owner terminal apparatus 300, the electronic apparatus 100 may generate and store authentication information for the control authority authentication of the guest terminal apparatus 200 at operation S1230 and transmit the generated authentication information to the guest terminal apparatus 200 at operation S1240. Here, the authentication information may include information on the owner terminal apparatus approving the approval request and information on the control authority approved by the owner terminal apparatus 300.

If the authentication information and the control command for the electronic apparatus 100 are received from the guest terminal apparatus 200, the electronic apparatus 100 may match the received authentication information to the stored authentication information to determine whether the control command is performed at operation S1250.

According to an embodiment of the present disclosure, when the received authentication information and the stored authentication information are matched to each other, the electronic apparatus 100 may perform the control command and then transmit a performance result message to the guest terminal apparatus 200, and when the received authentication information and the stored authentication information are not matched to each other, the electronic apparatus 100 may transmit a message informing that the guest terminal apparatus 200 does not have authority for controlling the electronic apparatus 100 to the guest terminal apparatus 200.

Meanwhile, according to an embodiment of the present disclosure, the authentication information may include information on an expiration time of the control authority for the electronic apparatus 100 of the guest terminal apparatus 200. In this case, in a case in which the expiration time included in the authentication information received from the guest terminal apparatus 200 elapses, the electronic apparatus 100 may not perform the control command received from the guest terminal apparatus 200.

Meanwhile, according to another embodiment of the present disclosure, the guest terminal apparatus 200 may request control authority to a plurality of electronic apparatuses. Here, in a case in which the owner terminal apparatus of the respective electronic apparatuses is the same as the owner terminal apparatus 300, the electronic apparatus 100 may receive information on control authority that the guest terminal apparatus 200 requests to a different electronic apparatus from the guest terminal apparatus 200.

Specifically, the guest terminal apparatus 200 may receive specification information of the electronic apparatus 100 including at least one of a type of power supply of the electronic apparatus 100, memory capacity thereof, a communication manner thereof, and a processor speed thereof from each of the plurality of electronic apparatuses. Accordingly, in a case in which the electronic apparatus 100 is selected among the electronic apparatus 100 and the different electronic apparatus based on the specification information of the electronic apparatus 100 and the specification information of the different electronic apparatus by the guest terminal apparatus 200, the electronic apparatus 100 may receive the information on the control authority that the guest terminal apparatus 200 requests to the different electronic apparatus from the guest terminal apparatus 200.

Accordingly, the electronic apparatus 100 may transmit the approval request for the respective control authorities that the guest terminal apparatus 200 requests to the electronic apparatus 100 and the different electronic apparatus to the owner terminal apparatus 300.

If the approval for the respective control authorities is received from the owner terminal apparatus 300, the electronic apparatus 100 may generate and store authentication information for control authority authentication for the electronic apparatus 100 and the different electronic apparatus of the guest terminal apparatus 200.

Meanwhile, according to an embodiment of the present disclosure, if integrated authentication information in which a plurality of authentication information are integrated and a control command are received from the guest terminal apparatus 200, the electronic apparatus 100 may determine whether the stored authentication information is included in the received integrated authentication information to determine whether the control command is performed. Here, the integrated authentication information may include at least two or more of authentication information capable of controlling at least one function of a plurality of functions that may be performed in the electronic apparatus 100, authentication information capable of controlling a function different from at least one function of the plurality of functions that may be performed in the electronic apparatus 100, and authentication information capable of controlling another electronic apparatus.

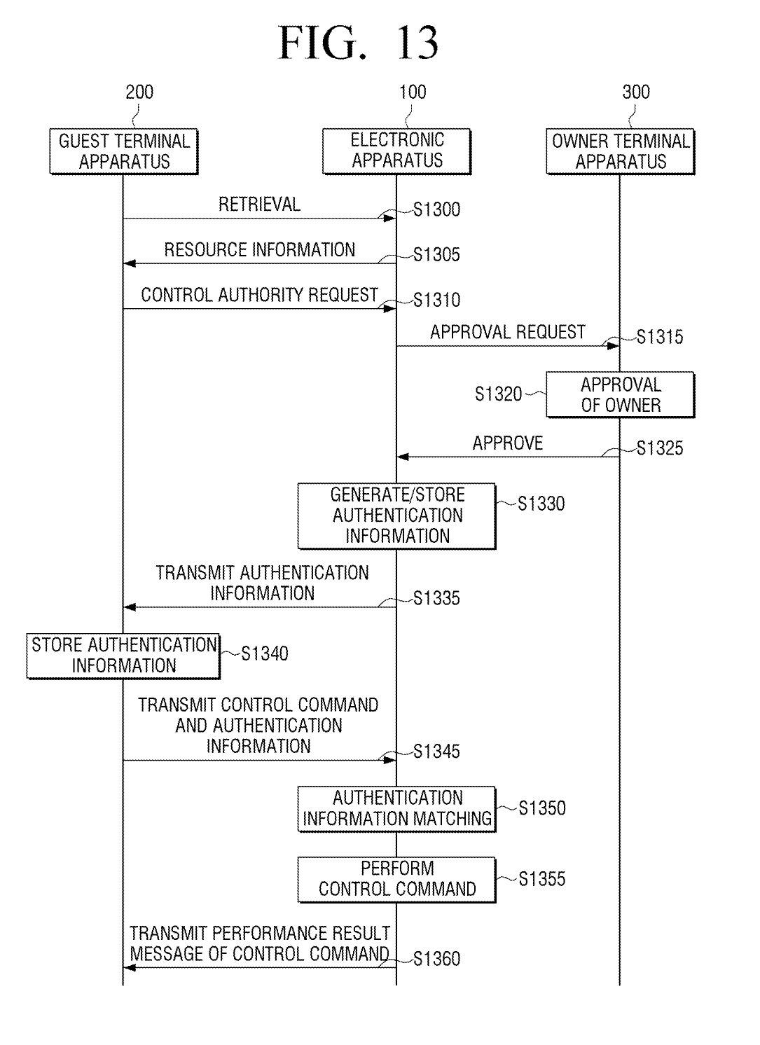

FIG. 13 is a sequence diagram illustrating an operation of a control authority authentication and processing system according to an embodiment of the present disclosure.

Referring to FIG. 13, the guest terminal apparatus 200 retrieves electronic apparatuses therearound at operation S1300. Here, the guest terminal apparatus 200 may request the electronic apparatus 100 to transmit information on a plurality of functions which may be performed in the electronic apparatus 100 during the retrieval.

Accordingly, the electronic apparatus 100 may transmit the information on the plurality of functions which may be performed in the electronic apparatus 100, that is, resource information, to the guest terminal apparatus 200 at operation S1305. Accordingly, the guest terminal apparatus 200 may select the electronic apparatus to which control authority is to be requested among the retrieved electronic apparatuses, and request control authority for a function to be controlled among the plurality of functions which may be performed in the corresponding electronic apparatus to the electronic apparatus 100 at operation S1310.

The electronic apparatus 100 receiving the control authority request may transmit an approval request for the requested control authority to the owner terminal apparatus 300 at operation S1315. Here, although not illustrated in the drawings, according to an embodiment of the present disclosure, if the electronic apparatus 100 receives the control authority request from the guest terminal apparatus 200, a list of the owner terminal apparatuses may be transmitted to the guest terminal apparatus 200, and if information on the owner terminal apparatus 300 selected from the list of the owner terminal apparatuses is transmitted from the guest terminal apparatus 200, the electronic apparatus 100 may also transmit the approval request to the selected owner terminal apparatus 300 from the guest terminal apparatus 200.

The owner terminal apparatus 300 displays the information included in the approval request, and if the owner confirms the information and then approves the approval request at operation S1320, the owner terminal apparatus 300 may transmit an approval message for the approval request to the electronic apparatus 100 at operation S1325.

Here, the owner may also approve the approval request by adding a condition to the approval request through the owner terminal apparatus 300 as described above. In this case, the approval message may also include information on the condition added by the owner.

The electronic apparatus 100 receiving the approval for the approval request from the owner terminal apparatus 300 may generate and store authentication information for control authority authentication for the electronic apparatus 100 of the guest terminal apparatus 200 at operation S1330 and transmit the generated authentication information to the guest terminal apparatus 200 at operation S1335. Here, the authentication information stored in the electronic apparatus 100 and the authentication information transmitted to the guest terminal apparatus 200 may be the same or be different according to an embodiment.

If the authentication information is received from the electronic apparatus 100, the guest terminal apparatus 200 may store the received authentication information at operation S1340. Here, the guest terminal apparatus 200 may also store the received authentication information as it is and may also generate and store new authentication information based on the received authentication information according to an embodiment. More particularly, in a case in which the authentication information that has been previously stored exists, the guest terminal apparatus 200 may integrate newly received authentication information with existing authentication information to manage it as one integrated authentication information. Further, in a case in which capacity of the integrated authentication information is increased to a predetermined size or more, the guest terminal apparatus 200 may also separate and manage the authentication information for each of the owners or the owner terminal apparatuses.

If the guest inputs the control command for controlling the electronic apparatus 100 through the guest terminal apparatus 200, the guest terminal apparatus 200 may transmit the stored authentication information together with the input control command to the electronic apparatus 100 at operation S1345.

If the control command and the authentication information are received from the guest terminal apparatus 200, the electronic apparatus 100 may match the stored authentication information and the authentication information received from the guest terminal apparatus 200 to each other at operation S1350, and determine whether the control command is performed according to the matching result.

If the authentication information is matched, the electronic apparatus 100 may perform the control command at operation S1355, and transmit a control command performance result message to the guest terminal apparatus 200 at operation S1360.

According to the diverse embodiments of the present disclosure as described above, the electronic apparatus 100 may authenticate and process the control authority without the server in the IoT environment. Accordingly, the privacy or security issue of the user which may occur during the control authority authentication may be addressed, and the authority control feature which is more suitable for the IoT environment may be supported.

Meanwhile, the operation of the processor 120 of the electronic apparatus 100 or the control authority authentication method of the electronic apparatus 100 according to the diverse embodiments described above may be generated in software and mounted in the electronic apparatus 100.

For example, a non-transitory computer readable medium having a program performing a control authority authentication method stored thereon may be installed in the electronic apparatus 100, wherein the control authority authentication method comprising receiving a control authority request from a guest terminal apparatus 200 requesting control authority for the electronic apparatus 100, transmitting an approval request for the control authority request to an owner terminal apparatus 300 having approval authority for a control of the electronic apparatus 100, generating and storing authentication information for control authority authentication of the guest terminal apparatus 200 when an approval for the approval request is received from the owner terminal apparatus 300, transmitting the generated authentication information to the guest terminal apparatus 200, and matching received authentication information and stored authentication information to each other when the authentication information and a control command for the electronic apparatus 100 are received from the guest terminal apparatus 200, to determine whether the control command is performed.

The operation of the processor 220 of the various guest terminal apparatuses 200 described above may also be generated in software and mounted in the guest terminal apparatus 200.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic apparatus comprising:
a communicator configured to communicate with a guest terminal apparatus requesting control authority for the electronic apparatus and an owner terminal apparatus having approval authority for a control of the electronic apparatus;
a storage; and
at least one processor configured to:
transmit an approval request for the control authority request to the owner terminal apparatus when the control authority request is received from the guest terminal apparatus,
generate authentication information for control authority authentication of the guest terminal apparatus to store the generated authentication information in the storage and to transmit the generated authentication information to the guest terminal apparatus, when an approval for the approval request is received from the owner terminal apparatus, and
match received authentication information and the stored authentication information to each other and to determine whether a control command is performed, when the authentication information and the control command for the electronic apparatus are received from the guest terminal apparatus.

2. The electronic apparatus of claim 1, wherein the at least one processor is further configured to:
transmit information on a plurality of functions which are performed in the electronic apparatus to the guest terminal apparatus, when a request for the information on the plurality of functions which are performed in the electronic apparatus is received from the guest terminal apparatus, and
transmit an approval request for at least one function for which the control authority is requested to the owner terminal apparatus, when a control authority request for the at least one function of the plurality of functions which are performed in the electronic apparatus is received from the guest terminal apparatus.

3. The electronic apparatus of claim 1,
wherein the storage is configured to store a list of owner terminal apparatuses having the approval authority for the control of the electronic apparatus, and
wherein the at least one processor is further configured to:
transmit the list of the owner terminal apparatuses to the guest terminal apparatus, when the control authority request is received from the guest terminal apparatus, and
transmit the approval request to a selected owner terminal apparatus, when information on the owner terminal apparatus selected from the list of the owner terminal apparatuses is received from the guest terminal apparatus.

4. The electronic apparatus of claim 1, wherein the authentication information includes information on the owner terminal apparatus approving the approval request and information on the approved control authority.

5. The electronic apparatus of claim 1,
wherein the authentication information includes information on an expiration time of the control authority for the electronic apparatus of the guest terminal apparatus, and
wherein the at least one processor does not perform the control command received from the guest terminal apparatus, when the expiration time included in the authentication information received from the guest terminal apparatus elapses.

6. The electronic apparatus of claim 1, wherein the at least one processor is further configured to:
transmit a performance result message to the guest terminal apparatus after performing the control command, when the received authentication information and the stored authentication information are matched to each other as a matching result of the authentication information, and
transmit a message informing that the guest terminal apparatus does not have authority to control the electronic apparatus to the guest terminal apparatus, when the received authentication information and the stored authentication information are not matched to each other.

7. The electronic apparatus of claim 1,
wherein the owner terminal apparatus has approval authority for a control of the electronic apparatus and a different electronic apparatus, and
wherein the at least one processor is further configured to:
transmit approval requests for the respective control authorities requested to the electronic apparatus and the different electronic apparatus to the owner terminal apparatus, when information on the control authority that the guest terminal apparatus requests to the different electronic apparatus is received from the guest terminal apparatus,
generate authentication information for control authority authentication for the electronic apparatus and the different electronic apparatus of the guest terminal apparatus to store the generated authentication information in the storage, and
transmit the generated authentication information to the guest terminal apparatus, when an approval for the respective control authorities is received from the owner terminal apparatus.

8. The electronic apparatus of claim 7, wherein the at least one processor is further configured to:
transmit specification information of the electronic apparatus including at least one of a type of power supply, memory capacity, a communication manner, or a processor speed of the electronic apparatus to the guest terminal apparatus, and
receive information on the control authority that the guest terminal apparatus requests to the different electronic apparatus from the guest terminal apparatus, when the electronic apparatus is selected among the electronic apparatus and the different electronic apparatus based on the specification information of the electronic apparatus and the specification information of the different electronic apparatus in the guest terminal apparatus.

9. The electronic apparatus of claim 1,
wherein the at least one processor is further configured to determine whether the stored authentication information is included in received integrated authentication information to determine whether the control command is performed, when the integrated authentication information in which a plurality of authentication information are integrated and the control command are received from the guest terminal apparatus, and
wherein the integrated authentication information includes at least two or more of authentication information controlling at least one function of a plurality of functions which are performed in the electronic apparatus, authentication information controlling a function different from the at least one function of the plurality of functions which are performed in the electronic apparatus, and authentication information controlling a different electronic apparatus.

10. A control authority authentication method of an electronic apparatus, the method comprising:
receiving a control authority request from a guest terminal apparatus requesting control authority for the electronic apparatus;
transmitting an approval request for the control authority request to an owner terminal apparatus having approval authority for a control of the electronic apparatus;
generating and storing authentication information for control authority authentication of the guest terminal apparatus, when an approval for the approval request is received from the owner terminal apparatus;
transmitting the generated authentication information to the guest terminal apparatus; and
matching received authentication information and the stored authentication information to each other to determine whether the control command is performed, when the authentication information and the control command for the electronic apparatus are received from the guest terminal apparatus.

11. The method of claim 10, further comprising transmitting information on a plurality of functions which are performed in the electronic apparatus to the guest terminal apparatus, when a request for the information on the plurality of functions which are performed in the electronic apparatus is received from the guest terminal apparatus,
wherein, in the receiving of the control authority request, a control authority request for the at least one function of the plurality of functions which are performed in the electronic apparatus is received from the guest terminal apparatus, and
wherein, in the transmitting of the approval request for the control authority request to the owner terminal apparatus, an approval request for at least one function for which the control authority is requested is transmitted to the owner terminal apparatus.

12. The method of claim 10, further comprising transmitting a list of owner terminal apparatuses having the approval authority for the control of the electronic apparatus to the guest terminal apparatus, when the control authority request is received from the guest terminal apparatus,
wherein the transmitting of the approval request for the control authority request to the owner terminal apparatus includes:
receiving information on the owner terminal apparatus selected from the list of the owner terminal apparatuses from the guest terminal apparatus, and
transmitting the approval request to the selected owner terminal apparatus.

13. The method of claim 10, wherein the authentication information includes information on the owner terminal apparatus approving the approval request and information on the approved control authority.

14. The method of claim 10,
wherein the authentication information includes information on an expiration time of the control authority for the electronic apparatus of the guest terminal apparatus, and
wherein, in the determining of whether the control command is performed, the control command received from the guest terminal apparatus is not performed, when the expiration time included in the authentication information received from the guest terminal apparatus elapses.

15. The method of claim 10, further comprising transmitting a performance result message to the guest terminal apparatus after performing the control command, when the received authentication information and the stored authentication information are matched to each other, and transmitting a message informing that the guest terminal apparatus does not have authority to control the electronic apparatus to the guest terminal apparatus, when the received authentication information and the stored authentication information are not matched to each other.

16. The method of claim 10,
wherein the owner terminal apparatus has approval authority for a control of the electronic apparatus and a different electronic apparatus,
wherein, in the transmitting of the approval request for the control authority request to the owner terminal apparatus, approval requests for the respective control authorities requested to the electronic apparatus and the different electronic apparatus are transmitted to the owner terminal apparatus, when information on the control authority that the guest terminal apparatus requests to the different electronic apparatus is received from the guest terminal apparatus, and
wherein, in the generating and storing of the authentication information, authentication information for control authority authentication for the electronic apparatus and the different electronic apparatus of the guest terminal apparatus is generated and stored, when an approval for the respective control authorities is received from the owner terminal apparatus.

17. The method of claim 16, further comprising transmitting specification information of the electronic apparatus including at least one of a type of power supply, memory capacity, a communication manner, or a processor speed of the electronic apparatus to the guest terminal apparatus,
wherein, in the transmitting of the approval request for the control authority request to the owner terminal apparatus, information on the control authority that the guest terminal apparatus requests to the different electronic apparatus is received, when the electronic apparatus is selected among the electronic apparatus and the different electronic apparatus based on the specification information of the electronic apparatus and the specification information of the different electronic apparatus in the guest terminal apparatus.

18. The method of claim 10,
wherein, in the determining of whether the control command is performed, whether the stored authentication information is included in received integrated authentication information is determined to determine whether the control command is performed, when the integrated authentication information in which a plurality of authentication information are integrated and the control command are received from the guest terminal apparatus, and
wherein the integrated authentication information includes at least two or more of authentication information controlling at least one function of a plurality of functions which are performed in the electronic apparatus, authentication information controlling a function different from the at least one function of the plurality of functions which are performed in the electronic apparatus, and authentication information controlling a different electronic apparatus.

19. A user terminal apparatus comprising:
a communicator configured to communicate with an electronic apparatus; and
at least one processor configured to:
transmit a control authority request for the electronic apparatus to the electronic apparatus, and
control an operation of the electronic apparatus by using received authentication information, when the control authority request is approved by an owner terminal apparatus having approval authority for a control of the electronic apparatus and the authentication information for control authority authentication for the electronic apparatus of the user terminal apparatus is received from the electronic apparatus.
